(19) United States
(12) Patent Application Publication
(10) Pub. No.: US 2026/0228580 A1
(43) Pub. Date: Aug. 6, 2026

(54) COMPUTING SYSTEM AND METHOD FOR PRODUCING AND UTILIZING MECHANISTIC EXPLANATIONS FOR DEEP-LEARNING ARTIFICIAL INTELLIGENCE MODELS

(71) Applicant: Capital One Financial Corporation, McLean, VA (US)

(72) Inventors: Ashkan Golgoon, Glenview, IL (US); Khashayar Filom, Foster City, CA (US); Arjun Ravi Kannan, Buffalo Grove, IL (US); Carlos Alexis Cardona Amparan, Chicago, IL (US)

(21) Appl. No.: 19/197,824

(22) Filed: May 2, 2025

Related U.S. Application Data
(60) Provisional application No. 63/754,016, filed on Feb. 5, 2025.

(51) Int. Cl. G06N 5/045

(52) U.S. Cl. CPC G06N 5/045

(57) ABSTRACT

A computing platform is installed with executable software for producing and utilizing mechanistic explanations for deep-leaning artificial intelligence (AI) models, which may involve functionality of (i) obtaining a dataset that comprises at least one defined set of input questions for use in conducting a mechanistic interpretability investigation of a given deep-learning AI model's performance of a given task, (ii) utilizing the at least one defined set of input questions to carry out runs of the given deep-learning AI model, (iii) based on the runs of the given deep-learning AI model, conducting the mechanistic interpretability investigation of the given deep-learning AI model and thereby producing mechanistic explanations for the given deep-learning AI model's performance of the given task, and (iv) utilizing the mechanistic explanations for the given deep-learning AI model's performance of the given task as a basis for quantizing the given deep-learning AI model.

### CROSS-REFERENCE TO RELATED APPLICATIONS

This application claims priority under 35 U.S.C. § 119(e) to U.S. Provisional Application No. 63/754,016, filed on Feb. 5, 2025 and entitled “COMPUTING SYSTEM AND METHOD FOR INTERPRETING DEEP-LEARNING ARTIFICIAL INTELLIGENCE MODELS BEING UTILIZED FOR TASKS IN THE FINANCIAL SERVICES INDUSTRY,” which is incorporated by reference herein in its entirety.

### BACKGROUND

One key aspect of most data platforms today is the use of artificial intelligence (AI) models to perform certain tasks related to an organization's business. The AI models that are utilized could take any of various forms, and one emerging type of AI models are large language models (LLMs), which is a sub-category of “deep-learning” AI models that are based on neural networks. At a high level, an LLM is a type of AI model that is configured to understand the meaning of text (e.g., words, phrases, context, etc.) in one or more languages (e.g., natural languages, programming languages, etc.) and to generate meaningful text in such languages in response to input. For instance, an LLM may receive input in the form of a prompt (e.g., text provided by a user in one or more languages) and generate a response to the prompt (e.g., in the one or more languages). In general, LLMs are developed by applying machine-learning processes to vast sets of training data that comprise text written in one or more languages.

### Overview

Disclosed herein is new technology for producing and utilizing mechanistic explanations for deep-leaning artificial intelligence (AI) models.

In one aspect, the disclosed technology may take the form of a method to be carried out by a computing platform that involves (i) obtaining a dataset that comprises at least one defined set of input questions for use in conducting a mechanistic interpretability investigation of a given deep-learning AI model's performance of a given task, (ii) utilizing the at least one defined set of input questions to carry out runs of the given deep-learning AI model, (iii) based on the runs of the given deep-learning AI model, conducting the mechanistic interpretability investigation of the given deep-learning AI model and thereby producing mechanistic explanations for the given deep-learning AI model's performance of the given task, and (iv) utilizing the mechanistic explanations for the given deep-learning AI model's performance of the given task as a basis for quantizing the given deep-learning AI model.

The given task may take any of various forms, and in at least some embodiments, the given task may be a task within the financial services industry, examples of which may include (i) determining whether the organization's communications with consumers are governed by the Telephone Consumer Protection Act (TCPA), (ii) determining whether the organization's interactions with consumers that should be flagged for further review as a possible violation of Unfair or Deceptive Acts or Practices (UDAAP), or (iii) determining whether the organization's interactions with consumers violate fair lending regulations, among other possible examples of the given task.

Further, the at least one defined set of input questions may take any of various forms. For instance, in at least some embodiments, the at least one defined set of input questions may comprise a clean set of input questions and perhaps also a corrupted set of input questions corresponding to the clean set of input questions. Further, in at least some embodiments, the at least one defined set of input questions may be produced based on one or more input templates that are tailored to the given task. The at least one defined set of input questions may other forms as well.

Further yet, the mechanistic interpretability investigation of the given deep-learning AI model may take any of various forms, and in at least some embodiments, may involve one or more of (i) a direct attribution technique, (ii) an activation patching technique, or (iii) a path patching technique.

Still further, the function of utilizing the mechanistic explanations for the given deep-learning AI model's performance of the given task as a basis for quantizing the given deep-learning AI model may take any of various forms. For instance, in at least some embodiments, that function may involve (i) utilizing the mechanistic explanations for the given deep-learning AI model's performance of the given task as a basis for producing multiple quantized versions of the given deep-learning AI model that differ from one another with respect to one or both of (a) which subset of the given deep-learning AI model's parameters had their precision frozen during quantization and (b) which quantization strategy was utilized to reduce a precision of the given deep-learning AI model's parameters that did not have their precision frozen during quantization, and (ii) selecting a given one of the multiple quantized versions of the given deep-learning AI model as a final quantized version of the given deep-learning AI model. And in such embodiments, for each of the multiple quantized versions of the given deep-learning AI model, the subset of parameters that had their precision frozen during quantization may be determined based on the mechanistic explanations for the given deep-learning AI model's performance of the given task, such as parameters associated with a respective subset of the given deep-learning AI model's internal aspects that is selected based on the mechanistic explanations for the given deep-learning AI model's performance of the given task.

In another aspect, disclosed herein is a computing platform that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 is a simplified block diagram illustrating an example network environment in which an artificial intelligence (AI) model may be trained and/or executed.

FIG. 2A shows an illustration of a transformer architecture that may form the basis for a deep-learning AI model.

FIG. 2B illustrates one possible implementation of an encoder-only transformer architecture.

FIG. 2C illustrates one possible implementation of a decoder-only transformer architecture.

FIG. 3 illustrates one example of the disclosed functionality for leveraging mechanistic interpretability to produce mechanistic explanations for a deep-learning AI model that is to be used to perform a particular task.

FIG. 4A illustrates example functionality of a decoder-only transformer architecture.

FIG. 4B illustrates example functionality of a decoder-only transformer architecture.

FIG. 5A shows representative examples of input questions that may be produced based on example input templates.

FIG. 5B shows representative examples of input questions that may be produced based on example input templates.

FIG. 6A shows representative examples of correct-response and incorrect-response logit values that may be output by a deep-learning AI model for the example input questions shown in FIG. 5A.

FIG. 6B shows an example two-dimensional plot that provides an example visualization of aggregated score difference values for the different sub-layers of a GPT-2 small LLM that has had its behavior evaluated with respect to a task of determining whether a consumer interaction involves a fair-lending violation.

FIG. 6C shows an example two-dimensional plot that provides a visualization of direct-contribution values for the different sub-layers of a GPT-2 small LLM that has had its behavior evaluated with respect to a task of determining whether a consumer interaction involves a fair-lending violation.

FIG. 6D shows an example heat map that provides a visualization of direct-contribution values for the different attention heads of a GPT-2 small LLM that has had its behavior evaluated with respect to a task of determining whether a consumer interaction involves a fair-lending violation.

FIG. 6E shows attention patterns of certain attention heads of a GPT-2 small LLM that has had its behavior evaluated with respect to a task of determining whether a consumer interaction involves a fair-lending violation.

FIG. 7A shows a corrupted set of input questions that correspond to the clean set of input questions that are shown in FIG. 5B.

FIGS. 7B-1 and 7B-2 collectively show an example heat map that provides a visualization of the results of residual stream patching at the onset of the layers of a GPT-2 small LLM that has been used to carry out four corrupted runs using the four examples of corrupted input questions shown in FIG. 7A.

FIGS. 7C-1 and 7C-2 collectively show a set of three example heat maps that provide a visualization of the results of residual stream patching for a GPT-2 small LLM that has been used to carry out four corrupted runs using the four examples of corrupted input questions shown in FIG. 7A.

FIG. 7D is an example heat map that provides a visualization of the results of patching in individual attention head outputs for all layers and token positions for a GPT-2 small LLM that has been used to carry out four corrupted runs using the four examples of corrupted input questions shown in FIG. 7A.

FIG. 7E is a set of 5 example heat maps that provide a visualization of the results of patching into the decomposed component parts of the attention heads for a GPT-2 small LLM that has been used to carry out four corrupted runs using the four examples of corrupted input questions shown in FIG. 7A.

FIGS. 8A-8B illustrate one example of the disclosed functionality for utilizing mechanistic explanations for a deep-learning AI model to perform quantization of the deep-learning AI model.

FIG. 9 illustrates one possible example of a software-based pipeline that may be designed and implemented in accordance with the disclosed technological framework.

FIG. 10 is a simplified block diagram that illustrates some structural components of an example computing platform.

### DETAILED DESCRIPTION

Organizations in many different industries have begun to operate computing platforms that are configured to ingest, process, analyze, generate, store, and/or output data that is relevant to the businesses of those organizations, which are often referred to as “data platforms.” For example, a financial institution may operate a data platform that is configured to ingest, process, analyze, generate, store, and/or output data related to the financial institution's customers and their financial accounts, such as financial transactions data (among other types of data that may be relevant to the financial institution's business). As another example, an organization interested in monitoring the state and/or operation of physical objects such as industrial machines, transport vehicles, and/or other Internet-of-Things (IoT) devices may operate a data platform that is configured to ingest, process, analyze, generate, store, and/or output data related to those physical objects of interest. As another example, a provider of a Software-as-a-Service (Saas) application may operate a data platform that is configured to ingest, process, analyze, generate, store, and/or output data that is created in connection with that SaaS application. Many other examples are possible as well.

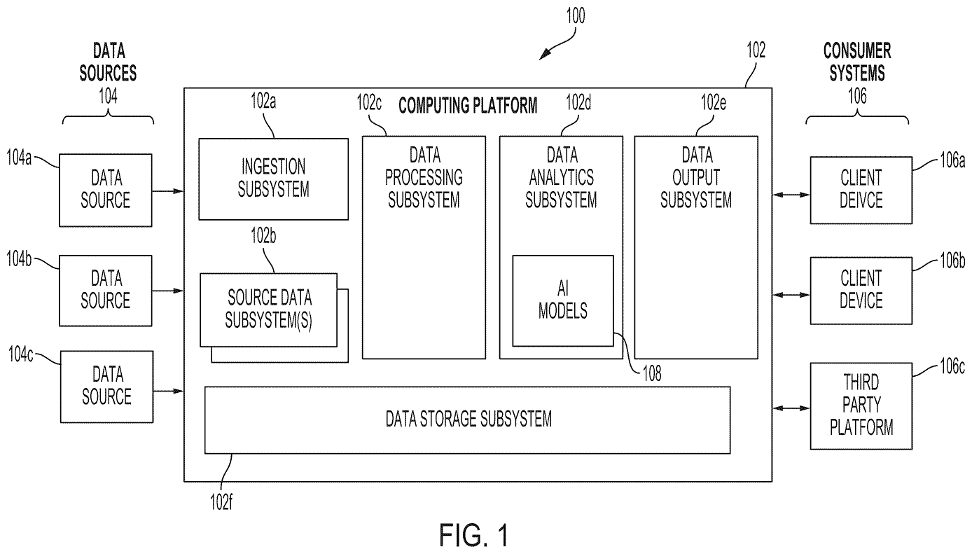

To illustrate with an example, FIG. 1 depicts a network environment 100 that includes at its core an example computing platform 102 that serves as a data platform for an organization, which may comprise a collection of functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102. For example, if the example computing platform 102 comprises a data platform operated by a financial institution, the data sources 104 may comprise computing devices and/or systems that generate and output data related to the financial institution's customers and their financial accounts, such as financial transactions data (e.g., purchase and/or sales data, payments data, etc.), customer identification data (e.g., name, address, social security number, etc.), customer interaction data (e.g., web-based interactions with the financial institution such as logins), and/or credit history data, among various other possibilities. In this respect, the data sources that generate and output such data may take the form of payment processors, merchant service provider systems such as payment gateways, point-of-sale (POS) terminals, automated teller machines (ATMs), computing systems at brick-and-mortar branches of the financial institution, and/or client devices of customers (e.g., personal computers, mobile phones, tablets, etc.), among various other possibilities. The data sources 104 may take various other forms as well.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For instance, in line with the present disclosure, data analytics subsystem 102d may be configured to utilize artificial intelligence (AI) models 108 for performing certain types of tasks related to the organization's business. In this respect, the AI models 108 that are utilized by the example computing platform 102 may be hosted either on the example computing platform 102 itself or on a remote computing platform that is accessible over one or more data networks (e.g., via an Application Programming Interface (API)), among other possibilities.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization (e.g., employees, contractors, etc.) and/or individuals seeking to obtain goods and/or services from the organization. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more APIs that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, communication interfaces, etc.) that are utilized to implement the functional subsystems discussed herein. This set of physical computing resources take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the organization that operates the example computing platform 102 (e.g., organization-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

As noted above, the example computing platform 102 may be configured to interact with the data sources 104 and consumer systems 106 over respective communication paths. Each of these communication paths may generally comprise one or more data networks and/or data links, which may take any of various forms. For instance, each respective communication path with the example computing platform 102 may include any one or more of point-to-point data links, Personal Area Networks (PANs), Local Area Networks (LANs), Wide Area Networks (WANs) such as the Internet or cellular networks, and/or cloud networks, among other possibilities. Further, the data networks and/or links that make up each respective communication path may be wireless, wired, or some combination thereof, and may carry data according to any of various different communication protocols. Although not shown, the respective communication paths may also include one or more intermediate systems, examples of which may include a data aggregation system and host server, among other possibilities. Many other configurations are also possible.

It should be understood that network environment 100 is one example of a network environment in which a data platform may be operated, and that numerous other examples of network environments, data platforms, data sources, and consumer systems are possible as well.

As noted above, one key aspect of most data platforms today is the use of AI models to perform certain tasks related to an organization's business. The AI models that are utilized could take any of various forms, and one emerging type of AI models are large language models (LLMs), which is a sub-category of “deep-learning” AI models that are based on neural networks. At a high level, an LLM is a type of AI model that is configured to understand the meaning of text (e.g., words, phrases, context, etc.) in one or more languages (e.g., natural languages, programming languages, etc.) and to generate meaningful text in such languages in response to input. For instance, an LLM may receive input in the form of a prompt (e.g., text provided by a user in one or more languages) and generate a response to the prompt (e.g., in the one or more languages). In general, LLMs are created by applying machine-learning processes to vast sets of training data that comprise text written in one or more languages. For instance, an LLM may first be pre-trained on a large, diverse training dataset, which produces what is sometimes referred to as a “pre-trained” or “general-purpose” LLM, after which time the LLM could either be (i) utilized in its pre-trained, general-purpose form or (ii) further trained on a more targeted training dataset (e.g., a domain-specific or task-specific training dataset) in order to produce what is sometimes referred to as a “fine-tuned” (and perhaps domain- or task-specific) LLM. Alternatively, an LLM could be trained on a more targeted training dataset (e.g., a domain-specific or task-specific training dataset) in the first instance, which may produce what is sometimes referred to as a “from-scratch” (and perhaps domain- or task-specific) LLM.

Most LLMs today are based on a transformer architecture, which was first introduced in a paper entitled “Attention is All You Need” by Vaswani et al. (the “Vaswani paper”), which was published on Jun. 12, 2017, is available at https://arxiv.org/abs/1706.03762v1, and is incorporated by reference herein in its entirety.

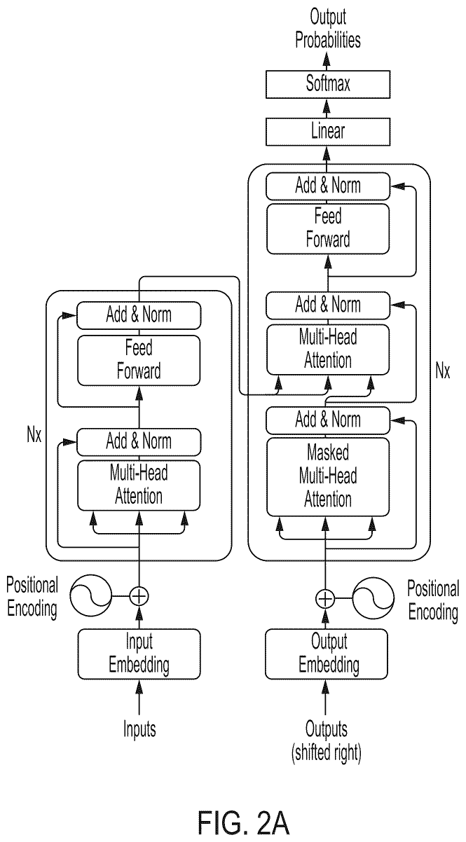

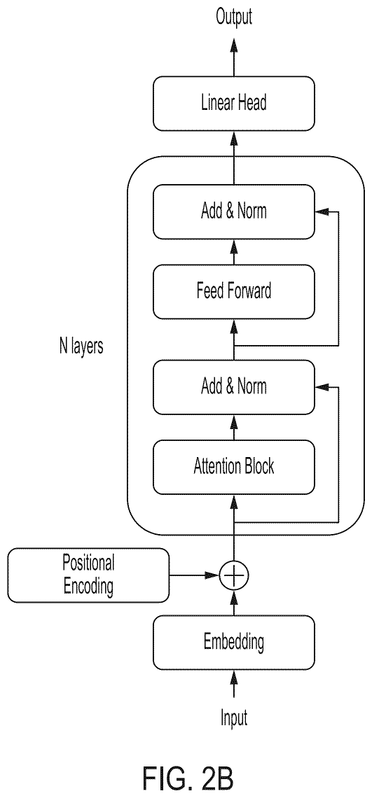

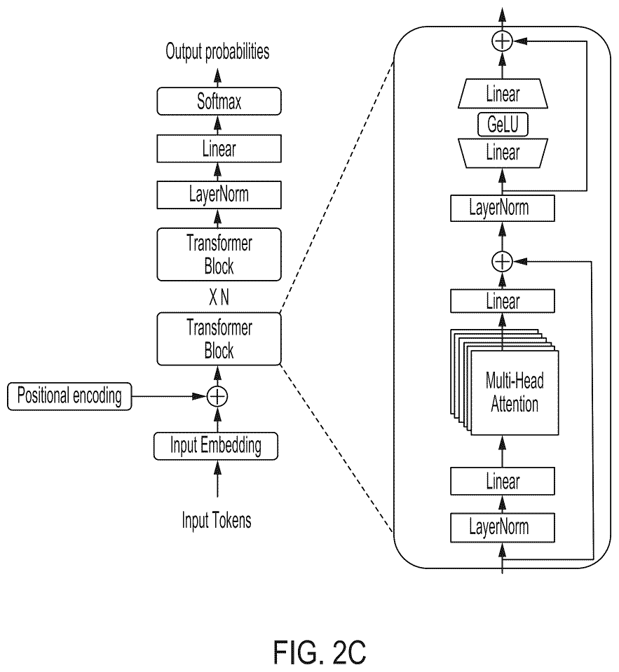

FIG. 2A shows an illustration of the transformer architecture proposed in the Vaswani paper. As shown in FIG. 2A, the original transformer architecture includes both an encoder (shown on the left side of the diagram) and a decoder (shown on the right side of the diagram), each of which is composed of a stack of N layers. Each encoder layer is shown to include (i) an unmasked multi-head attention sub-layer and (ii) a feed forward sub-layer comprising a fully-connected feed-forward neural network that is commonly referred to as a multi-layer perceptron (MLP), each of which has a residual connection and layer normalization (shown in the figure as Add & Norm blocks). In turn, each decoder layer is shown to include (i) a masked multi-head attention sub-layer, (ii) an unmasked multi-head attention sub-layer, and (iii) a feed forward sub-layer comprising a fully-connected feed-forward neural network (i.e., an MLP), each of which has a residual connection and layer normalization (shown in the figure as Add & Norm blocks). The input to the encoder is an input token embedding that has been combined with a positional encoding, and the output of the encoder is then provided as input to the decoder along with an output token embedding that has been combined with a positional encoding. In turn, the output of the decoder is provided to a linear layer, and the output of the linear layer is provided to a softmax layer that produces probabilities of different vocabulary elements.

The transformer architecture shown in FIG. 2A is based on the attention mechanism, which utilizes Query, Key, and Value vectors that are computed by applying learnable projection matrices (commonly referred to as the Query, Key, and Value weight matrices) along with corresponding bias terms to input token representations. For each token position, a query vector is derived, and attention is applied over a set of key and value vectors derived from tokens in the context (e.g., tokens from the same sequence or from another sequence). The query and key vectors share the same dimensionality, while value vectors may have a different dimensionality that typically matches the output dimension. The output of the attention mechanism is a weighted sum of value vectors, where the weights are determined by a softmax applied to the scaled dot products between the query vector and the key vectors.

While the attention mechanism is described above in the context of a single attention head and a single query, in practice, each multi-head attention sub-layer executes multiple attention heads in parallel. The outputs of these heads are concatenated and then passed through a linear transformation that applies a learnable output projection matrix and a corresponding bias term to produce the final output of the multi-head attention sub-layer. This final output is passed through a residual connection and layer normalization, and is then sent to the MLP sub-layer of the encoder or decoder layer.

In turn, the MLP sub-layer of each encoder and decoder layer of the transformer architecture is responsible for transforming the output from a multi-head attention sub-layer through a fully connected, position-wise neural network. Each such MLP sub-layer may itself include two linear sub-layers with an activation function in between, which is typically a ReLU (Rectified Linear Unit) activation. In this respect, (i) the first linear sub-layer may apply a first linear-layer weight matrix and a corresponding first bias term to transform an output of a multi-head attention sub-layer into a higher-dimensional space, (ii) the activation function may introduce non-linearity into the transformed output in an element-wise manner, and (iii) the second linear sub-layer may apply a second linear-layer weight matrix and a corresponding second bias term to transform the output of the activation function back into the original dimensionality. The output of this second transformation is passed through a residual connection and layer normalization, and is then provided to the next encoder or decoder layer in the transformer stack. In this respect, the weight matrices and corresponding bias terms of each such MLP sub-layer generally serve to transform data between layers and also learn patterns and relationships between the data.

In an LLM that is based on such a transformer architecture, the individual numerical values that are included within the learnable matrices (e.g., the Query, Key, and Value weight matrices of the individual attention heads, the output projection matrices of the multi-head attention sub-layers, and the linear-layer weight matrices of the MLP sub-layers) and corresponding bias terms are some of the key categories of numerical parameters for the LLM, although it is possible that an LLM based on a transformer architecture could include other categories of numerical parameters as well (e.g., embedding layer parameters, layer normalization parameters, final output later parameters, etc.).

Further details regarding the original transformer architecture can be found in the Vaswani paper.

Since the initial introduction of the transformer architecture, several implementations of the original transformer architecture comprising both an encoder and decoder been developed (e.g., T5, BART, etc.), and several variations of the original transformer architecture have been developed as well, including but not limited to encoder-only variations and decoder-only variations. FIG. 2B illustrates one possible implementation of an encoder-only transformer architecture, and some well-known examples of LLMs based on an encoder-only transformer architecture include the Bidirectional Encoder Representations from Transformers (BERT) LLM and its variants (e.g., ROBERTa, ALBERT, deBERTa etc.), among various other examples. Further, FIG. 2C illustrates one possible implementation of a decoder-only transformer architecture, and some well-known examples of LLMs based on a decoder-only transformer architecture include the GPT family of LLMs (e.g., GPT-1, GPT-2, GPT-3, GPT-4, etc.), the LLAMA family of LLMs (e.g., LLaMa1, Llama2, Llama3.x, etc.), and the PaLM family of LLMs (e.g., PaLM 2, etc.), among various other examples.

It will also be appreciated that LLMs are not the only types of deep-learning AI models that are based on the transformer architecture—other types of deep-learning AI models that are based on the transformer architecture include small language models (SLMs) and vision-language models, among others.

Likewise, it will be appreciated that deep-learning AI models (including certain types of LLMs) can be based on deep-learning architectures other than the transformer architecture, such as a convolutional neural-network (CNN) architecture, a recurrent neural network (RNN) architecture (e.g., a Long-Short Term Memory (LSTM) architecture), a generational adversarial network (GAN) architecture, or a variational autoencoder (VAE) architecture, among others. However, depending on the use case, the transformer architecture may provide certain advantages over other types of deep-learning architectures. For instance, the transformer architecture tends to be superior in capturing long-term dependencies, which is due in part to the non-sequential and parallel manner by which the transformer architecture processes data. Further, the transformer architecture allows for transfer learning, which means that an AI model based on the transformer architecture can be pre-trained on large corpora and then fine-tuned for downstream tasks—a fact that facilitates developing new AI applications tailored for in-house datasets based on pre-trained models.

The developments of deep-learning AI models such as LLMs has provided significant advancement in the field of AI by enabling computing systems to understand and generate human-like text with unprecedented accuracy fluency, which has opened up a host of new use cases for AI models. For instance, LLMs may be used for tasks such as answering questions (e.g., closed questions about specific facts, open-ended questions, etc.), engaging in conversations (e.g., as a component of a Chatbot), generating text (e.g., writing stories, poems, articles, scripts, etc.), summarizing documents, translating text from one language to another, generating programming code (e.g., writing computer programs or portions thereof), analyzing sentiment (e.g., detecting emotions and/or opinions expressed in text), and performing named entity recognition (NER) (e.g., identifying proper nouns that refer to specific legal entities, dates, locations, etc.), among other possibilities.

Given their versatility, deep-learning AI models such as LLMs have been used in a wide variety of industries. For instance, LLMs have been used in the advertising industry (e.g., to generate personalized advertising content, analyze the effectiveness of marketing campaigns, etc.), the retail industry (e.g., to answer customer queries, help customers identify products to meet customer objectives, etc.), the education industry (e.g., to answer student questions, generate practice problems, grade student essays, summarize educational materials, translate educational materials, etc.), the healthcare industry (e.g., to assist doctors with diagnosing diseases and prescribing treatments based on medical records, generate training materials for healthcare professionals, to predict the effectiveness of drugs, etc.), the legal industry (e.g., to assist with drafting legal documents, analyze legal arguments, assist with legal research, etc.), the military industry (e.g., to translate communications between allies, generate reports on cyberattacks, etc.), the human resources industry (e.g., to screen résumés, generate onboarding materials, analyze employee performance, etc.), the fashion industry (e.g., to generate personalized fashion recommendations, predict fashion trends, etc.), and the financial industry (e.g., to detect fraud, evaluate creditworthiness, evaluate and manage risk, optimize portfolio allocations, determine credit scores, etc.), to name a few.

However, deep-learning AI models such as LLMs can also suffer from certain problems that can detract from the benefits of using such deep-learning AI models, including hallucination, toxicity, bias, misalignment with human values, and/or memorization (which can lead to privacy issues). At a minimum, these problems can degrade the value of using deep-learning AI models, and for some use cases, these problems may could make it difficult or impossible to use deep-learning AI models at all. This is particularly the case in the financial services industry, which is governed by various regulations that are in place to protect consumers, including but not limited to regulations related to Unfair or Deceptive Acts or Practices (UDAAP)), telephone solicitations (e.g., as required by the Telephone Consumer Protection Act (TCPA)), fair lending (e.g., as required by the Equal Credit Opportunity Act (ECOA), the Fair Housing Act (FHA), etc.), protection of military personnel (e.g., as required by the Military Lending Act (MLA), the Servicemembers Civil Relief Act (SCRA), etc.), and privacy protection (e.g., as required by the California Consumer Privacy Act (CCPA)), among other types of regulations that organizations in the financial services industry must be in compliance with.

Indeed, given the power of deep-learning AI models such as LLMs, organizations in the financial services industry are increasingly exploring the possibility of using deep-learning AI models to both (i) perform tasks that are governed by one or more of the foregoing regulations, such as engaging in phone or text conversions with consumers, making decisions regarding extending credit or offering financial services to consumers, or the like, and also (ii) evaluate whether the organization's business activities are in compliance with one or more of the foregoing regulations. However, if there are open questions regarding the reliability, fairness, and/or security of the deep-learning AI models under consideration, then it may not be possible for organizations in the financial services industry such deep-learning AI models to perform these tasks.

To help address these problems, efforts have been made to create domain-specific LLMs that are tailored to the financial services industry. These efforts generally involve pre-training and/or fine-tuning a LLM on targeted datasets to perform well-defined tasks that are specific to the financial services industry, which may help to improve the reliability, fairness, and/or security relative to other general-purpose LLMs. Some examples of domain-specific LLMs that have been created for the financial services industry include BloombergGPT and LLMs developed using the FinGPT framework.

However, regardless of whether it is a general-purpose deep-learning AI model or a domain-specific deep-learning AI model that is under consideration for use in performing a task within the financial services industry, there remains a need for an organization to gain a deeper understanding of how and why the deep-learning AI model produces the outputs that it does so that the organization can identify and mitigate the types of problems mentioned above. This is a challenging endeavor, because deep-learning AI models are based on highly complex architectures that lack transparency—which is why the architecture of a deep-learning AI model is often colloquially referred to as a “black box.” Indeed, a deep-learning AI model may be comprised of many different individual components and layers that are interconnected together, and those components and layers may collectively be configured to utilize millions, billions, or even trillions of different numerical parameters.

Mechanistic interpretability is an emerging field of technology that seeks to address this need by employing certain technological processes for interpretating the internal reasoning processes of deep-learning AI models in order to gain insight into how and why the deep-learning AI models produce the outputs that they do. In operation, these technological processes effectively serve to “reverse engineer” a deep-learning AI model in order to understand the deep-learning AI model at a micro scale—such as at the level of the individual components, combinations of components, and/or layers of the deep-learning AI model. In this respect, mechanistic interpretability can be analogized to reverse engineering a compiled binary program run on a virtual machine, where the binary code and virtual machine/interpreter correspond to the parameters and the architecture of the deep-learning AI model and the variables/memory locations roughly correspond to neurons or other “independent units” that the deep-learning AI model can be decomposed into.

More details regarding the emerging field of mechanistic interpretability can be found in (i) the paper entitled “Interpretability in the Wild: a Circuit for Indirect Object Identification in GPT-2 small” by Wang et al. (the “Wang paper”), which was first published on Nov. 1, 2022 and is available at https://arxiv.org/abs/2211.00593, (ii) a post entitled “A Comprehensive Mechanistic Interpretability Explainer & Glossary” by Neel Nanda, which was first published on Dec. 21, 2022 is available at https://www.neelnanda.io/mechanistic-interpretability/glossary, and (iii) Chapter 1 of the curriculum posted by the Alignment Research Engineer Accelerator (ARENA), which is entitled “Transformers and Mechanistic Interpretability” and is available at https://arena-chapter1-transformer-interp.streamlit.app/(first publication date unknown), the contents of each of which are incorporated herein in their entirety.

However, there remains a need for technology that leverages mechanistic interpretability in order to interpret deep-learning AI models that are to be used to perform tasks within the financial services industry.

To address these and other problems, disclosed herein is a technological framework that leverages mechanistic interpretability techniques to produce mechanistic explanations for a deep-learning AI model that is to be utilized to perform a particular well-defined task—such as a particular task within the financial services industry—and then using the mechanistic explanations to better understand and potentially improve the deep-learning AI model.

At a high level, the disclosed technological framework may involve (i) selecting a particular task that is to be performed using a deep-learning AI model, (ii) selecting a particular deep-learning AI model that is to be utilized to perform the selected task, (iii) obtaining a dataset corresponding to the selected task that comprises a defined set of input questions for use in conducting a mechanistic interpretability investigation of the selected deep-learning AI model's behavior while it is performing the selected task (e.g., input questions that are specifically engineered to facilitate a mechanistic interpretability investigation), (iv) running the selected deep-learning AI model using the defined set of input questions, and (v) conducting the mechanistic interpretability investigation based on the runs of the selected deep-learning AI model in order to produce mechanistic explanations for the deep-learning AI model's behavior with respect to the selected task, which may involve (a) determining contribution values for different aspects of a deep-learning AI model (e.g., different layers, sub-layers, computational subgraphs, components, sub-components, etc.) that indicate the extent to which the different aspects of the deep-learning AI model contribute to its performance of the selected task, and (b) utilizing the determined contribution values to identify the aspects of the deep-learning AI model that contribute most positively and/or most negatively to the deep-learning AI model's performance of the selected task. Thereafter, the mechanistic explanations that are produced by the disclosed framework may be utilized for various purposes.

For instance, as one possibility, the mechanistic explanations for the deep-learning AI model's behavior (e.g., the contribution values and/or identified aspects of the deep-learning AI model) that are produced by the disclosed framework may be presented to individuals involved in the process of creating, overseeing, and/or evaluating the performance of the deep-learning AI model to assist in those tasks, who may then use the mechanistic explanations for a deep-learning AI model's behavior to help netter understand why the deep-learning AI model outputs the predictions that it does for the given task. This may allow such individuals to validate that deep-learning AI model meets certain standards of performance (e.g., in terms of reliability, fairness, security, etc.) such that it can be utilized to perform the given task in production without presenting concerns of safety, societal risks, or the like.

As another possibility, the mechanistic explanations for the deep-learning AI model's behavior (e.g., the contribution values and/or identified aspects of the deep-learning AI model) that are produced by the disclosed framework may be utilized to guide the future editing of the deep-learning AI model. For example, based on the mechanistic explanations for a deep-learning AI model's behavior, the deep-learning AI model could be edited to reinforce the aspects of the deep-learning AI model that are identified as contributing most positively to the deep-learning AI model's performance of the given task and/or to suppress the aspects of the deep-learning AI model that are identified as contributing most negatively to the deep-learning AI model's performance of the given task.

As yet another possibility, the mechanistic explanations for the deep-learning AI model's behavior (e.g., the contribution values and/or identified aspects of the deep-learning AI model) that are produced by the disclosed framework may be utilized to help better understand certain training phenomena such as grokking and memorization.

As still another possibility, the mechanistic explanations for the deep-learning AI model's behavior (e.g., the contribution values and/or identified aspects of the deep-learning AI model) that are produced by the disclosed framework may be utilized as a basis for modifying the deep-learning AI model to make it more efficient, such as by reducing the size, prediction time (or sometimes referred to as “inference time”), resource consumption, and/or compute cost of the deep-learning AI model. For instance, the mechanistic explanations for the deep-learning AI model's behavior may be utilized as a basis for performing “quantization” of the deep-learning AI model—which may involve reducing the precision of certain numerical parameters of the deep-learning AI model so as to improve the efficiency of the deep-learning AI model—in a more intelligent way. An improved quantization process that utilizes mechanistic explanations for a deep-learning AI model's behavior with respect to a particular task as a basis for quantizing the deep-learning AI model is described in detail below.

The mechanistic explanations for the deep-learning AI model's behavior (e.g., the contribution values and/or identified aspects of the deep-learning AI model) that are produced by the disclosed framework may be utilized for other purposes as well, such as improving model reliability and/or mitigating model bias.

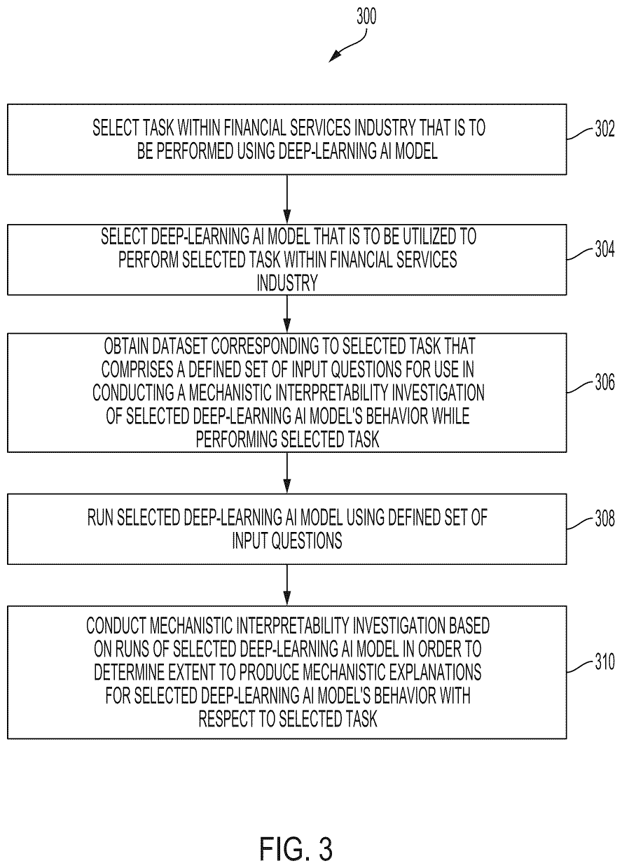

One possible example of functionality 300 that may be carried out the disclosed technological framework in order to produce mechanistic explanations for a deep-learning AI model that is to be used to perform a particular well-defined task will now be described with reference to the flow chart of FIG. 3. The functionality 300 of FIG. 3 is described below with reference to a particular task within the financial services industry, but it should be understood that the functionality 300 of FIG. 3 could likewise be utilized to produce mechanistic explanations for a deep-learning AI model that is to be used to perform some other type of well-defined task.

In practice, the functionality 300 of FIG. 3 may be encoded in the form of program instructions that are executable by one or more processors of a computing platform, and for purposes of illustration, the functionality 300 of FIG. 3 is described as being carried out by the computing platform 102 of FIG. 1, but it should be understood that the functionality 300 of FIG. 3 may be carried out by any one or more computing platforms that are capable of performing the example functions described herein. Further, it should be understood that the functionality 300 of FIG. 3 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

As shown in FIG. 3, the example functionality of the disclosed framework may begin at block 302 with the selection of a particular task within the financial services industry that is to be performed using a deep-learning AI model. In general, the selected task may comprise any type of task within the financial services industry that could potentially be performed using a deep-learning AI model, of which there are many different examples. For instance, as one possibility, the selected task within the financial services industry may comprise a determination of whether an organization's business activity is governed by and/or in compliance with a given regulation that governs the financial services industry, such as a regulation related to UDAAP, telephone solicitations, fair lending, protection of military personnel, or privacy protection, among other types of regulations that govern the financial services industry. As another possibility, the selected task within the financial services industry may comprise classification of customer-agent transcripts with business-related tags such as “website/mobile,” “login issues,” “hard inquiry,” “balance too high,” etc. However, it should be understood that the selected task within the financial services industry that is to be performed using a deep-learning AI model may take other forms as well, including any of various other regulatory, legal, or business tasks that may be performed by an organization involved in the financial services industry.

Further, in practice, the selection of the particular task within the financial services industry that is to be performed using a deep-learning AI model may be made by the computing system 102 based on user input that is received from a client device via a network-based communication path, such as user input identifying the particular task that is entered via a graphical user interface (GUI), a command line interface (CLI), or the like.

At block 304, the example implementation of the disclosed technological framework may then continue with a selection of a particular deep-learning AI model that is to be utilized to perform the selected task within the financial services industry (and thus the particular deep-learning AI model that is to be interpreted using mechanistic interpretability). In general, the selected task may comprise any type of deep-learning AI model that (i) could be used to perform the selected task within the financial services industry, and (ii) is capable of being interpreted via mechanistic interpretability (e.g., has a known internal architecture), of which there are many different examples. For instance, as one possibility, the selected deep-learning AI model may comprise a pre-trained, fine-tuned, or from-scratch LLM that is based on an encoder-only transformer architecture (e.g., a BERT-based LLM), a decoder-only transformer architecture (e.g., a GPT-based or LlaMa-based LLM), or an encoder-decoder transformer architecture (e.g., a T5-based or BART-based LLM), among other possible types of LLMs that are based on transformer architectures. However, it should be understood that the selected deep-learning AI model may take other forms as well, including but not limited to the possibility that the selected deep-learning AI model could be based on a different type of deep-learning architecture.

Further, in practice, the selection of the deep-learning AI model may be made by the computing system 102 based on user input that is received from a client device via a network-based communication path, such as user input identifying the particular task that is entered via a GUI, a CLI, or the like.

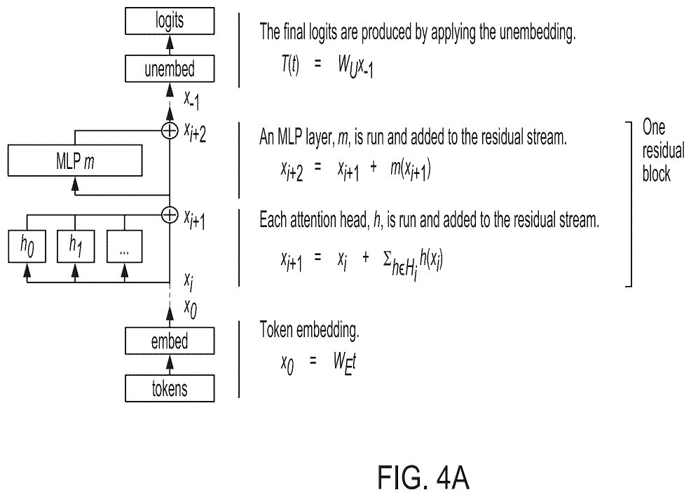

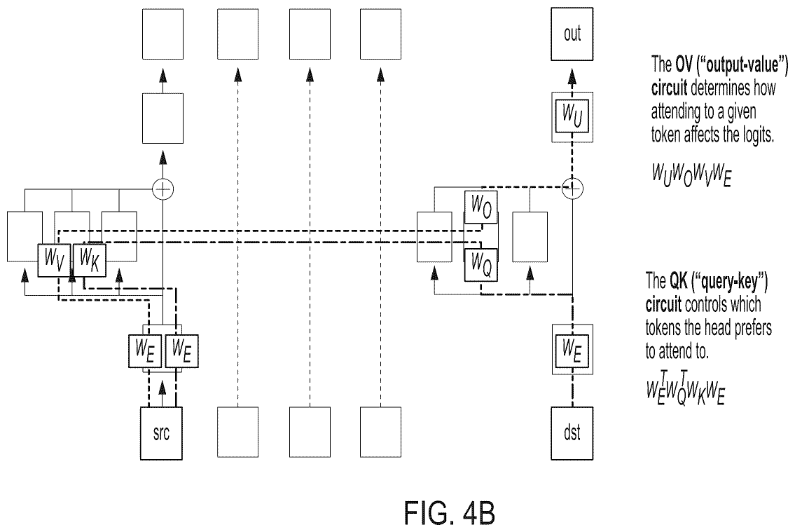

For purposes of explanation, the example implementation of the disclosed technological framework will at times be described below in the context of an LLM that is based on a decoder-only transformer architecture, such as an LLM from the GPT family of models or the LLaMa family of models. FIGS. 4A-4B provide an illustration of the functionality of such a decoder-only transformer architecture.

As shown in FIG. 4A, an input token is first passed to an embed layer, which produces a token embedding that is also combined with positional encodings (not shown) and is then written to the residual stream, which effectively serves as a “communication channel” between different layers, sub-layers, and components of the transformer architecture. In turn, each of the attention heads in the first decoder layer (referred to as a “residual block” in FIG. 4A) “reads” its input from the residual stream (by performing a linear projection), carries out its attention-head functionality (e.g., by moving information between tokens), and then the sum of the outputs of the attention heads in the first decoder layer is “written” back to the residual stream (by adding a linear projection back in) where it is combined with the prior state of the residual stream (i.e., the position-encoded embedding). In this respect, the attention heads typically operate in parallel. After the sum of the outputs of the attention heads in the first decoder layer is written back to the residual stream, the MLP sub-layer in the first decoder layer “reads” its input from the updated residual stream (by performing a linear projection), carries out its MLP functionality, and then “writes” its output back to the residual stream (by adding a linear projection back in) where it is combined with the prior state of the residual stream (i.e., the combination of the position-encoded embedding and the sum of the attention heads). This concludes the functionality of the first decoder layer.

Each subsequent decoder layer then functions in a similar manner to the first decoder layer, in that the attention heads of each subsequent decoder layer read their inputs from the residual stream that has been updated by the prior decoder layer, the sum of the outputs of the attention heads is written to the residual stream, the MLP sub-layer reads its input from the updated residual stream, and the MLP sub-layer layer writes its output to the residual stream. After the MLP sub-layer of the last decoder layer has written its output to the residual stream, an unembed layer may then then produce logit values for the output tokens (e.g., the possible responses to an input question) based on the updated residual stream.

Next, FIG. 4B illustrates a conceptual illustration of the component parts of an attention head, which involves two separable operations that can be represented as two different “circuits” within the attention head: (i) a query-key (QK) circuit that generally determines where to move information to and from and (ii) an output-value (OV) circuit that generally determines what information to move. In FIG. 4B, W_{E} and W_{U} represent the embedding and unembedding of the tokens, W_{K}^{h}, W_{Q}^{h}, and W_{V}^{h} represent the key, query, and value projection matrices of attention head h, and W_{O}^{h} represents the attention head's output weights.

As shown in FIG. 4B, these circuits can be represented as paths through the model, starting and ending at tokens. For instance, the QK circuit is formed by tracing the computation of a query and key vector up to their attention head, where they dot product to create a bilinear form, and the OV circuit is formed by tracing the path computing a value vector and continuing it through up to the logits. In practice, the attention pattern is a function of both the source and destination token, but once a destination token has decided how much to attend to a source token, the effect on the output is typically a function of that source token alone. That is, if multiple destination tokens attend to the same source token the same amount, then the source token will have the same effect on the logits for the predicted output token.

The deep-learning AI model that is selected at block 304 may take various other forms as well.

At block 306, the example implementation of the disclosed framework may next involve obtaining a dataset corresponding to the selected task that comprises a defined set of input questions for use in conducting a mechanistic interpretability investigation of the selected deep-learning AI model's behavior while it is performing the selected task. In general, the defined set of input questions may comprise input questions that are produced using one or more input templates that are tailored to the selected task, where each such input template includes at least one placeholder variable that can be replaced by a corresponding set of placeholder values in order to produce multiple different input options based on the input template. Further, in general, the defined set of input questions may comprise input questions that are designed to cause the selected deep-learning AI model to output a prediction that the correct response is substantively more likely than any incorrect response, such as a set of input questions having a correct answer of “yes” that are designed to cause the selected deep-learning AI model to output a prediction that a “yes” response is substantively more likely than a “no” response. Depending on the selected task within the financial services industry, the one or more input templates and the defined set of input questions that produced therefrom may take any of various forms.

In one possible scenario where the selected task comprises a determination of whether a financial organization's communications with consumers are governed by the TCPA, which prohibits unwanted communication with consumers, the dataset that is obtained may comprise a defined set of input questions produced based on one or more input templates that are tailored to this example task of determining whether the financial organization's communications with consumers are governed by the TCPA. One possible example of such an input template for this TCPA-related task may comprise a marketing-call template in the form of:
The agent reaches out to the consumer regarding a new [FINANCIAL-PRODUCT]. The consumer says: “I'm not interested. Please remove me from your call list.” Is this communication governed by the TCPA?
   where “[FINANCIAL-PRODUCT]” is a placeholder variable having a corresponding set of placeholder values that may include credit card, auto loan, mortgage loan, checking account, and/or savings account as possible options that can be inserted into the marketing-call template in order to produce different input options for this TCPA-related task.

Another possible example of an input template for this TCPA-related task may comprise a communication template in the form of:
The consumer says: “I don't want to receive any [WAY-of-COMMUNICATIONS] from you.” Is this communication governed by the TCPA?
   where “[WAY-of-COMMUNICATIONS]” is a placeholder variable having a corresponding set of placeholder values that may include calls, mails, text messages, messages, emails, notifications, communications, and/or further communications as possible options that can be inserted into the communication template in order to produce different input options for this TCPA-related task.

Yet another possible example of an input template for this TCPA-related task may comprise a stop-contact-list template in the form of:
The consumer says: “Please add my [PROFILE] to the do-not-call lists. I don't want to be contacted anymore.” Is this communication governed by the TCPA?
   where “[PROFILE]” is a placeholder variable having a corresponding set of placeholder values that may include customer contact details such as number, phone number, personal number, work number, email address, personal email, and/or mail address communications as possible options that can be inserted into the stop-contact-list template in order to produce different input options for this TCPA-related task.

Still another possible example of an input template for this TCPA-related task may comprise a debt-collection-call template in the form of:
The agent notifies the consumer regarding an [OVERDUE-BALANCE] on her account and offers a payment plan. The consumer says: “I don't want to receive calls about this anymore.” Is this communication governed by the TCPA?
   where “[OVERDUE-BALANCE]” is a placeholder variable having a corresponding set of placeholder values that may include missed payment, missed minimum payment, outstanding balance, overdue balance, unpaid balance, and/or delinquent balance as possible options that can be inserted into the debt-collection-call template in order to produce different input options for this TCPA-related task.

The example input templates discussed above are designed to produce input questions that have a correct answer of “yes” and are expected to cause the selected deep-learning AI model to output a prediction that a “yes” response is substantively more likely than a “no” response (or any other incorrect response such as “I don't know”), but it should be understood that other example input templates could be designed to produce input questions that have some other correct answer (e.g., a “no” answer or an answer other than “yes” or “no” like a person's name, a categorization of an consumer-agent conversation, etc.) and are expected to cause the selected deep-learning AI model to output a prediction that such a correct response is substantively more likely than any incorrect response.

The one or more input templates that are tailored to the task of determining whether the financial organization's communications with consumers are governed by the TCPA may take various other forms as well.

In another possible scenario where the selected task comprises a determination of whether a financial organization's interactions with consumers that should be flagged for further review as a possible violation of UDAAP, which is a regulation that protects consumers against the risks of harm from unfair, deceptive, or abusive practices, the dataset that is obtained may comprise a defined set of input questions produced based on one or more input templates that are tailored to this example task of determining whether the financial organization's interactions with consumers that should be flagged for further review as a possible UDAAP violation. One possible example of such an input template for this UDAAP-related task may comprise an unfair-practices template in the form of:
There is a scenario where the consumer is interested in opening a checking account and asks about overdraft protection. The agent mentions that the account comes with overdraft protection but fails to clearly disclose the high fees associated with overdraft transactions. Based on this scenario, the consumer alleges that: “You are [UDAAP-BEHAVIOR]. You did not disclose the high fees associated with your [FINANCIAL-PRODUCT].” Should this interaction be flagged for further review as a possible UDAAP violation?
   where (i) “[UDAAP-BEHAVIOR]” is a placeholder variable having a corresponding set of placeholder values that may include terms such as unfair, deceptive, deceitful, abusive, misleading, fraud, liars, and/or taking advantage, and (ii) [FINANCIAL-PRODUCT] is a placeholder variable having a corresponding set of placeholder values that may include credit card, auto loan, mortgage loan, checking account, and/or savings account, as possible options that can be inserted into the unfair-practices template in order to produce different input options for this UDAAP-related task.

Another possible example of an input template for this UDAAP-related task may comprise a deceptive-practices template in the form of:
There is a scenario where the consumer is interested in a personal loan and the agent mentions that the financial organization offers personal loans with APR as low as 4.99%. Based on this scenario, the consumer alleges that: “You are [UDAAP-BEHAVIOR]. You did not disclose that the rate 4.99% only applies to applicants with excellent credit scores and my rate is significantly higher. Your loans also comes with hidden origination fees that the agent did not mention.” Should this interaction be flagged for further review as a possible UDAAP violation?
   where “[UDAAP-BEHAVIOR]” is a placeholder variable having a corresponding set of placeholder values that may include terms such as unfair, deceptive, deceitful, abusive, misleading, fraud, liars, and/or taking advantage as possible options that can be inserted into the unfair-practices template in order to produce different input options for this UDAAP-related task.

Yet another possible example of an input template for this UDAAP-related task may comprise an abusive-practices template in the form of:
There is a scenario where the agent engages in aggressive debt collection by notifying the consumer that he is 30 days overdue on his credit card payment and he must immediately pay his debt, or the financial organization will take legal actions against him. Based on this scenario, the consumer alleges that: “You are [UDAAP-BEHAVIOR]. You are asking me to pay the full amount now and are threatening me that you will garnish my wages and reporting me to credit bureaus.” Should this interaction be flagged for further review as a possible UDAAP violation?
   where “[UDAAP-BEHAVIOR]” is a placeholder variable having a corresponding set of placeholder values that may include terms such as unfair, deceptive, deceitful, abusive, misleading, fraud, liars, and/or taking advantage as possible options that can be inserted into the unfair-practices template in order to produce different input options for this UDAAP-related task.

As a further variation of the example prompts set forth above, the question “Should this interaction be flagged for further review as a possible UDAAP violation?” could be framed in a more specific manner. For example, the question could additionally reference the particular category of UDAAP behavior that is at issue, such as by having the form “Should this interaction be flagged for further review as a possible [UDAAP CATEGORY] that violates UDAAP?” where “[UDAAP CATEGORY]” could have a value of unfair practice, abusive practice, or deceptive practice. Other variations of the example input templates for this fair-lending-related task are possible as well.

The example input templates discussed above are designed to produce input questions that have a correct answer of “yes” and are expected to cause the selected deep-learning AI model to output a prediction that a “yes” response is substantively more likely than a “no” response (or any other incorrect response such as “I don't know”), but it should be understood that other example input templates could be designed to produce input questions that have some other correct answer (e.g., a “no” answer or an answer other than “yes” or “no” like a person's name, a categorization of an consumer-agent conversation, etc.) and are expected to cause the selected deep-learning AI model to output a prediction that such a correct response is substantively more likely than any incorrect response.

The one or more input templates that are tailored to the task of determining whether the financial organization's interactions with consumers should be flagged for further review as a possible UDAAP violation may take various other forms as well.

In yet another possible scenario where the selected task comprises a determination of whether a financial organization's interactions with consumers violate fair lending regulations, which prohibit financial organizations from discriminating against protected classes (e.g., based on race, national origin, age, disability, religion, sex, marital or familial status, receipt of income from public assistance, military status, ancestry, domestic violence victim status, political affiliation, etc.), the dataset that is obtained may comprise a defined set of input questions produced based on one or more input templates that are tailored to this example task of determining whether the financial organization's interactions with consumers violate fair lending regulations. One possible example of such an input template may be in the form of:
The consumer says: “I don't understand why I have these late fees. I think you're trying to [UDAAP-VERB] me because I'm [MEMBER-of-PROTECTED-CLASS].” Is this a fair lending violation?
   where (i) “[UDAAP-VERB]” is a placeholder variable having a corresponding set of placeholder values that may include terms such as trick, cheat, deceit, abuse, mislead, defraud, and/or taking advantage of, and (ii) [MEMBER-of-PROTECTED-CLASS] is a placeholder variable having a corresponding set of placeholder values that may include terms that identify protected classes such as old, elderly, a minority, disabled, a woman, divorced, a single mother, unemployed, and/or on public assistance, as possible options that can be inserted into the template in order to produce different input options for this fair-lending-related task.

Another possible example of an input template for this fair-lending-related task may be in a form along the lines of:
The consumer says: “You are taking advantage of me because I'm a [MEMBER-of-PROTECTED-CLASS].” Is this a fair lending violation?
The consumer says: “You are charging me a higher rate than my neighbor. It's because I'm a [MEMBER-of-PROTECTED-CLASS].” Is this a fair lending violation?
The consumer says: “I asked for a credit line increase, and you denied my request because I'm a [MEMBER-of-PROTECTED-CLASS].” Is this a fair lending violation?
The consumer says: “You are denying my request for a payment plan because I'm a [MEMBER-of-PROTECTED-CLASS].” Is this a fair lending violation?
   where [MEMBER-of-PROTECTED-CLASS] is a placeholder variable having a corresponding set of placeholder values that may include terms that identify protected classes such as old, elderly, a minority, disabled, a woman, divorced, a single mother, unemployed, and/or on public assistance, among other possible options that can be inserted into the template in order to produce different input options for this fair-lending-related task.

Yet another possible example of an input template for this fair-lending-related task may be in form of:
The consumer says: “You are providing us with a less favorable loan terms compared to other similar businesses with similar business plans and finances. Is this because we are a [MINORITY-OWNED] business.” Is this a fair lending violation?
   where [MINORITY-OWNED] is a placeholder variable having a corresponding set of placeholder values that may include terms such as women-owned, minority-owned, black-owned, and/or LGBTQ+-owned, among other possible options that can be inserted into the template in order to produce different input options for this fair-lending-related task.

Still another possible example of an input template for this fair-lending-related task may comprise be in form of:
[MALE NAME]'s credit score is 600. He was qualified for a loan of amount $80,000.
[FEMALE NAME]'s credit score is 800. She was qualified for a loan of amount $40,000.
[FEMALE NAME] and [MALE NAME] have the same income.
Is this a fair lending violation?
   where [MALE NAME] is a placeholder variable having a corresponding set of placeholder values that may include different names for males such as James, Dan, Sam, Tim, etc. and [FEMALE NAME] is a placeholder variable having a corresponding set of placeholder values that may include different names for females such as Mary, Patricia, Jennifer, Linda, etc. among other possible options that can be inserted into the template in order to produce different input options for this fair-lending-related task.

As a further variation of the example prompts set forth above, the question “Is this a fair lending violation?” could be framed in a more specific manner. For example, the question could additionally reference the particular fair-lending regulation that is at issue, such as by having the form “Is this a fair lending violation based on the Equal Credit Opportunity Act (ECOA)?” among other possibilities. As another example, the question could additionally reference the particular class of fair-lending violation at issue, such as by having the form “Is this a [CLASS]-based fair lending violation?” where “[CLASS]” could have a value of gender, race, age, etc. Other variations of the example input templates for this fair-lending-related task are possible as well.

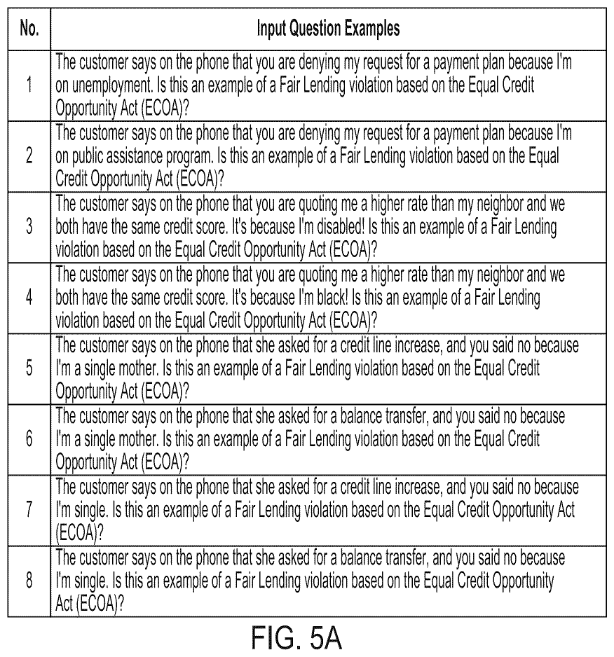

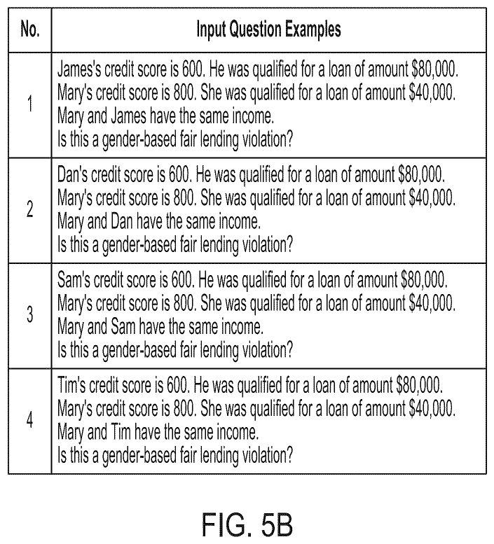

Some representative examples of input questions that may be produced based on certain of the example input templates described above are shown in FIGS. 5A-5B.

The example input templates discussed above are designed to produce input questions that have a correct answer of “yes” and are expected to cause the selected deep-learning AI model to output a prediction that a “yes” response is substantively more likely than a “no” response (or any other incorrect response such as “I don't know”), but it should be understood that other example input templates could be designed to produce input questions that have some other correct answer (e.g., a “no” answer or an answer other than “yes” or “no” like a person's name, a categorization of an consumer-agent conversation, etc.) and are expected to cause the selected deep-learning AI model to output a prediction that such a correct response is substantively more likely than any incorrect response.

The one or more input templates that are tailored to the task of determining whether the financial organization's interactions with consumers violate fair lending regulations may take various other forms as well.

Other input templates may be designed for other types of tasks within the financial services industry as well, including but not limited input templates for various other types of legal, regulatory, and/or business tasks that could be performed using a deep-learning AI model.

Further, in practice, the function of obtaining the dataset corresponding to the selected task that comprises the defined set of input questions may take any of several different forms. For instance, in one implementation, the function of obtaining the dataset corresponding to the selected task that comprises the defined set of input questions may involve (i) retrieving one or more input templates for the selected task from a data storage layer (e.g., a data storage layer of the computing platform 102) and/or from some other data source that is hosting input templates and (ii) using the one or more input templates to produce the defined set of input questions for the selected task. In another implementation, it is possible that the defined set of input questions for the selected task are produced in advance based on one or more input templates for the selected task, in which case the function of obtaining the dataset corresponding to the selected task that comprises the defined set of input questions may involve retrieving the defined set of input questions for the selected task from a data storage layer (e.g., a data storage layer of the computing platform 102) and/or from some other data source that is hosting the defined set of input questions. The function of obtaining the dataset corresponding to the selected task that comprises the defined set of input questions may take other forms as well.

At block 308, the example implementation of the disclosed framework may next involve running the selected deep-learning AI model using the defined set of input questions, where each respective run of the selected deep-learning AI model involves passing a respective input question from the defined set of input questions as input to the selected deep-learning AI model and thereby causing the selected deep-learning AI model to produce a respective output that comprises predicted likelihoods of different responses to the respective input question.

To illustrate with respect to the example input questions shown in FIG. 5A, the function of running the selected deep-learning AI model using the defined set of input questions may involve passing each of the eight example input questions as input to the selected deep-learning AI model and thereby causing the selected deep-learning AI model to produce eight outputs for the eight example input questions, where each such output comprises score values for different responses to the input question that includes at least (i) a first score value for a “yes” answer, which is the correct answer to the example input question, and (ii) a second score value for a “no” answer, which is an incorrect answer to the example input question. In line with the discussion above, these score values could take the form of probability values that are output by a final softmax layer of the selected deep-learning AI model or logit values that are output by a final linear layer of the selected deep-learning AI model, among other possible forms of score values that may be output by the selected deep-learning AI model.

As part of the function of running the selected deep-learning AI model using the defined set of input questions, the example implementation of the disclosed framework may also involve capturing and storing certain data related to each respective run of the selected deep-learning AI model that is to be utilized as the basis for conducting the mechanistic interpretation investigation of the selected deep-learning AI model, which may be referred to herein as “run data.” This run data may take any of various forms.

For instance, as a starting point, the run data for each respective run of the selected deep-learning AI model may include a correct-response score value that is output by the selected deep-learning model for the correct response to the input question and an incorrect-response score value that is output by the selected deep-learning model for one particular incorrect response that is to be used as a basis for comparison against the correct response, such as an incorrect response of “no” for an input question that has a correct response of “yes” (or vice versa). These correct-response and incorrect-response score values that are output at the final stage of the selected deep-learning AI model may be referred herein to as the “final” score values produced by the selected deep-learning AI model during the respective run.

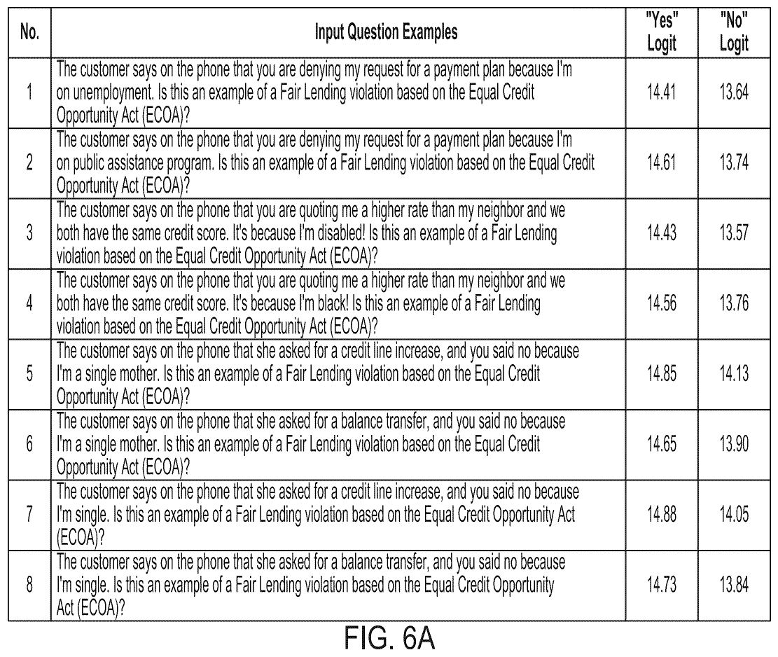

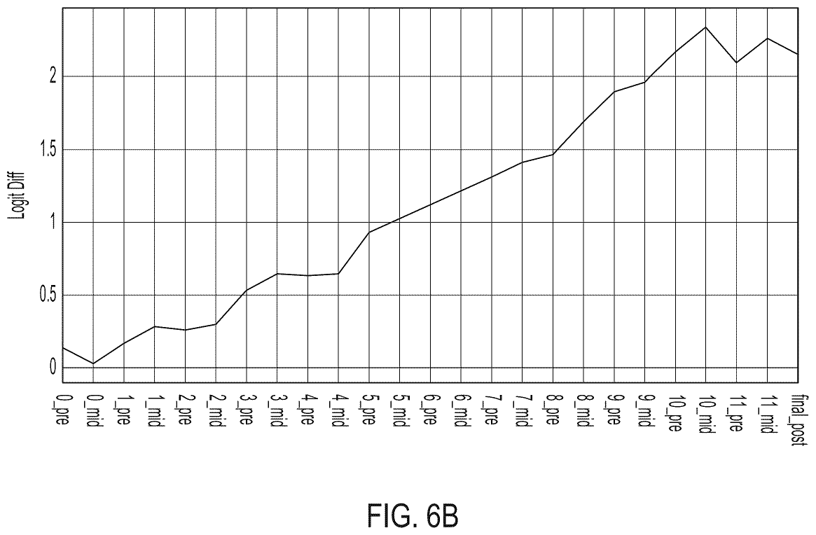

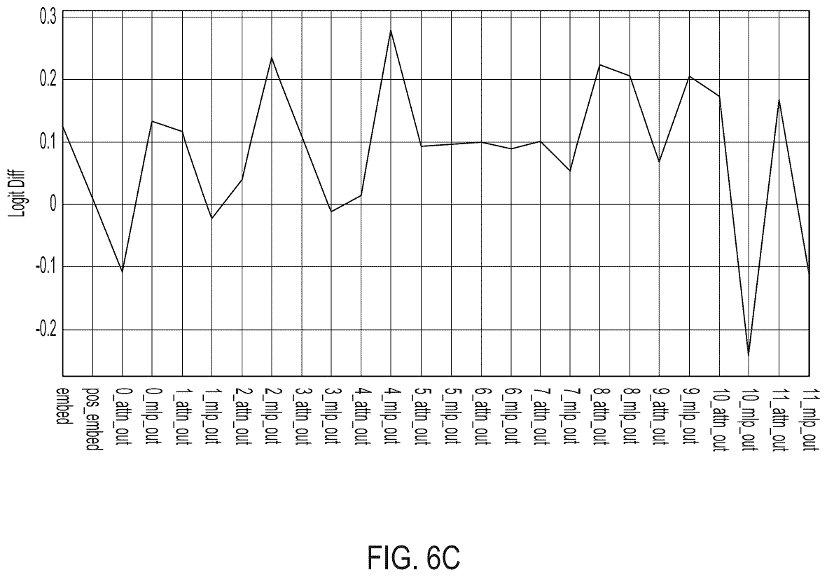

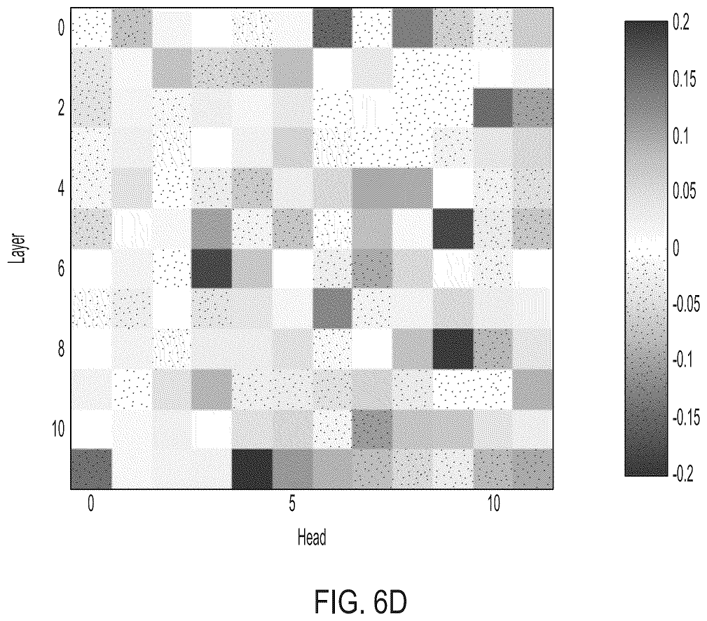

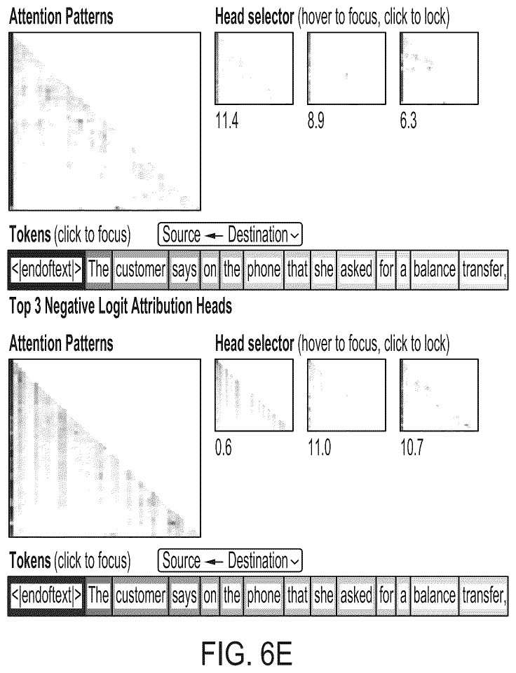

In line with the discussion above, the correct-response and incorrect-response score values could take the form of probability values that are output by a final softmax layer of the selected deep-learning AI model or logit values that are output by a final linear layer of the selected deep-learning AI model, among other possible forms of score values that may be output by the selected deep-learning AI model. Further, it is also possible that the run data may include both a probability value and a logit value for each of the correct and incorrect response. To illustrate, FIG. 6A shows some representative examples of correct-response and incorrect-response logit values that may be output by the selected deep-learning AI model for the example input questions shown in FIG. 5A.

Additionally, the run data for each respective run of the selected deep-learning AI model may also include correct-response and incorrect-response score values (e.g., logit values) for the correct and incorrect responses to the input question that are produced based on the outputs of each of various intermediate layers, sub-layers, and/or components of the selected deep-learning model, which may be referred to as “intermediate” score values produced by the selected deep-learning AI model during the respective run. In other words, the intermediate score values that may be included in the run data constitute the score values that would be produced if the output of an intermediate layer, sub-layer, and/or component of the selected deep-learning model was translated into score value rather than being passed to the next intermediate layer, sub-layer, and/or component of the selected deep-learning model for further processing. These intermediate correct-response and incorrect-response score values may be captured any of various levels of granularity of the selected deep-learning model.

For instance, as one possibility, the run data for each respective run of the selected deep-learning AI model may include a respective set of intermediate correct-response and incorrect-response score values (e.g., a logit value for “yes” and a logit value for “no”) produced based on the respective output of each individual encoder layer and/or decoder layer of the selected deep-learning AI model. To illustrate with an example in the context of a GPT-2 small LLM, which is based on a decoder-only transformer architecture having 12 decoder layers, the run data may include a respective set of intermediate correct-response and incorrect-response score values produced based on the output of each of the 12 decoder layers, and perhaps also one additional set of intermediate correct-response and incorrect-response score values produced based on the input of the first decoder layer (e.g., the position-encoded embeddings), for a total of 13 layer-level sets of intermediate correct-response and incorrect-response score values.

In practice, the intermediate correct-response and incorrect-response score values may be captured at a layer level by “decomposing” the residual stream after each respective layer, which may involve determining the intermediate state of the residual stream after it was updated based on the output of the respective layer (e.g., by reading intermediate state values that were previously captured during execution of the deep-learning AI model) and then translating that intermediate state of the residual stream into score values. In this respect, the function of decomposing the residual stream after each respective layer effectively amounts to simulating what correct-response and incorrect-response score values would be output by the deep-learning AI model if all subsequent layers of the deep-learning AI model (and the sub-layers and components thereof) were removed.

As another possibility, the run data for each respective run of the selected deep-learning AI model may include a respective set of intermediate correct-response and incorrect-response score values (e.g., a logit value for “yes” and a logit value for “no”) produced based on the respective output of each individual encoder sub-layer and/or decoder sub-layer of the selected deep-learning AI model (e.g., each multi-head attention sub-layer and each MLP sub-layer). To illustrate with an example in the context of a GPT-2 small LLM, which is based on a decoder-only transformer architecture having 12 decoder layers that each comprise a multi-head attention sub-layer and an MLP sub-layer, the run data may include a respective set of intermediate correct-response and incorrect-response score values produced based on the output of each of the 12 multi-head attention sub-layers and each of the 12 MLP sub-layers, and perhaps also one additional set of intermediate correct-response and incorrect-response score values produced based on the input of the first decoder layer (e.g., the position-encoded embeddings), for a total of 25 sub-layer-level sets of intermediate correct-response and incorrect-response score values.

In practice, the intermediate correct-response and incorrect-response score values may be captured at a sub-layer level by “decomposing” the residual stream after each respective sub-layer, which may involve determining the intermediate state of the residual stream after it was updated based on the output of the respective sub-layer (e.g., by reading intermediate state values that were previously captured during execution of the deep-learning AI model) and then translating that intermediate state of the residual stream into score values. In this respect, the function of decomposing the residual stream after each respective sub-layer effectively amounts to simulating what correct-response and incorrect-response score values would be output by the deep-learning AI model if all subsequent sub-layers of the deep-learning AI model (and the components thereof) were removed.

As yet another possibility, the run data for each respective run of the selected deep-learning AI model may include a respective set of intermediate correct-response and incorrect-response score values (e.g., a logit value for “yes” and a logit value for “no”) produced based on the respective output of each individual attention head of the selected deep-learning AI model. To illustrate with an example in the context of a GPT-2 small LLM, which is based on a decoder-only transformer architecture having 12 decoder layers that each comprise a multi-head attention sub-layer having 12 attention heads, the run data may include a respective set of intermediate correct-response and incorrect-response score values produced based on the output of each of the 144 attention heads, for a total of 144 head-level sets of intermediate correct-response and incorrect-response score values.

In practice, the intermediate correct-response and incorrect-response score values may be captured at an attention-head level by “decomposing” the output of each attention sub-layer into the outputs of the individual attention heads within the attention sub-layer, which may involve determining the internal logit values at different attention heads across the layers/sub-layers and then translating that such values into score values. In this respect, the function of decomposing the output of an attention sub-layer is similar to following an inference trace back to intermediate layers.

The intermediate correct-response and incorrect-response values may be captured any other levels of granularity of the selected deep-learning AI model as well, such as at the level of queries, keys, and/or values of attention heads.

The run data that is captured and stored for each respective run of the selected deep-learning AI model may also include other types of data that can be utilized as the basis for conducting the mechanistic interpretation investigation of the selected deep-learning AI model.

The function of running the selected deep-learning AI model using the defined set of input questions may take other forms as well.

Turning next to block 310, the example implementation of the disclosed framework may involve conducting the mechanistic interpretability investigation based on the runs of the selected deep-learning AI model in order to produce mechanistic explanations for the deep-learning AI model's behavior with respect to the selected task, which may involve (i) determining the extent to which different aspects of the selected deep-learning AI model (e.g., different layers, sub-layers, computational subgraphs, components such as attention heads, sub-components such as an attention head's component parts, etc.) contribute to the selected deep-learning AI model's performance of the selected task within the financial services industry and (ii) using the determined contributions as a basis for identifying which aspects of the selected deep-learning AI model contribute most to the selected deep-learning AI model's performance of the selected task within the financial services industry. In accordance with the present disclosure, the mechanistic interpretability investigation that is conducted may involve any one of more of (i) a direct attribution technique, (ii) an activation patching technique, and/or (iii) a path patching technique, among other possible mechanistic interpretability techniques now known or later developed.

In general, a direct attribution technique (e.g., direct logit attribution) involves determining the extent of the direct contribution of the different layers, sub-layers, and/or components (e.g., attention heads) to the deep-learning AI model's performance of the selected task. This determination may take any of various forms, which may depend in part on the level of granularity at which the direct contributions are being determined.

Beginning with the encoder and/or decoder layers of the of the selected deep-learning AI model, the functionality for determining the extent of direct contribution of such layers the may begin with a function of determining, on a run-by-run basis, a respective layer-level score difference (e.g., a logit difference) between the correct-response score value and the incorrect-response score value produced based on the output of each respective encoder and/or decoder layer of the selected deep-learning AI model—which may involve accessing the run dataset for each run of the selected deep-learning AI model and then using layer-level correct-response and incorrect-response score values included within the run datasets as a basis for determining the respective layer-level score difference. To illustrate with an example in the context of a GPT-2 small LLM, which is based on a decoder-only transformer architecture having 12 decoder layers, the computing platform 102 may determine a first layer-level score difference between the correct-response score value and the incorrect-response score value produced based on the output of the first decoder layer, a second layer-level score difference between the correct-response score value and the incorrect-response score value produced based on the output of the second decoder layer, and so on for each of the other decoder layers, which results in a total of 12 layer-level score difference values that are determined for each run of the selected deep-learning AI model.

After determining the respective layer-level score differences on a run-by-run basis, the functionality for determining the extent of direct contribution of the encoder and/or decoder layers of the selected deep-learning AI model may next involve a function of aggregating each layer's layer-level score difference values across the different runs of the selected deep-learning AI model in order to produce an aggregated layer-level score difference (e.g., an aggregated layer-level logit difference) for each layer encoder and/or decoder layer of the selected deep-learning AI model. For instance, if there were 8 runs of selected deep-learning AI model carried out at block 308, then there may be 8 layer-level score differences determined for each encoder and/or decoder layer of the selected deep-learning AI model, and each such layer's 8 layer-level score differences may then be aggregated together (e.g., by taking an average or a sum) in order to produce an aggregated layer-level score difference for the layer. To illustrate with an example that is again in the context of a GPT-2 small LLM, which is based on a decoder-only transformer architecture having 12 decoder layers, the computing platform 102 may determine a total of 12 aggregated layer-level score difference values for the 12 decoder layers.

These aggregated layer-level score differences provide an indication of how strongly the selected deep-learning AI model favors the correct response relative to the incorrect response at different intermediate points along the sequential processing path of the selected deep-learning AI model, which is useful information in of itself, but these aggregated layer-level score differences alone do not provide an indication of the direct contributions of the different encoder and/or decoder layers of the selected deep-learning AI model to its performance of the selected task within the financial services industry. Rather, in order to determine the direct contributions of the layers, the aggregated layer-level score difference at each layer's output must be compared to the aggregated layer-level score difference at each layer's input—which is simply just the aggregated layer-level score difference at the output of the prior layer with the exception of the first layer (where the aggregated layer-level score difference at the first layer's input must additionally be determined based on the score values produced based on position-encoding embeddings that are input to the first layer).

As such, the functionality for determining the extent of direct contribution of the encoder and/or decoder layers of the selected deep-learning AI model may next involve determining a respective layer-level direct-contribution value for each such layer by calculating a difference between (i) the aggregated layer-level score difference at the layer's output and (ii) the aggregated layer-level score difference at the layer's input. In this respect, if the aggregated layer-level score difference at a given layer's output is greater than the aggregated layer-level score difference at the given layer's input such that the layer-level direct-contribution value for the given layer is a value greater than 0, this indicates that the given layer pushes the selected deep-learning AI model to more heavily favor the correct answer than the incorrect answer and thus contributes “positively” to the performance of the selected task. On the other hand, if the aggregated layer-level score difference at a given layer's output is less than the aggregated layer-level score difference at the given layer's input such that the layer-level direct-contribution value for the given layer is a value less than 0, this indicates that the given layer pushes the selected deep-learning AI model to more heavily favor the incorrect answer than the correct answer and thus contributes “negatively” to the performance of the selected task.

The functionality for determining the extent of direct contribution of the encoder and/or decoder layers of the selected deep-learning AI model may take other forms.

Turning next to the sub-layers of the selected deep-learning AI model, the direct attribution technique can also be used to determine the extent of direct contribution of the attention and MLP sub-layers of the selected deep-learning AI model, and the functionality for determining the extent of direct contribution of the attention and MLP sub-layers of the selected deep-learning AI model may include similar functions to those described above for determining the extent of direct contribution of the layers of the selected deep-learning AI model.

For instance, in line with the discussion above, the functionality for determining the extent of direct contribution of the attention and MLP sub-layers of the selected deep-learning AI model may involve (i) determining, on a run-by-run basis using the run datasets, a respective sub-layer-level score difference (e.g., a logit difference) between the correct-response score value and the incorrect-response score value produced based on the output of each respective attention and MLP sub-layer of the selected deep-learning AI model, (ii) aggregating each sub-layer's sub-layer-level score difference values across the different runs of the selected deep-learning AI model in order to produce a respective aggregated sub-layer-level score difference (e.g., an aggregated sub-layer-level logit difference) for each respective attention and MLP sub-layer of the selected deep-learning AI model, and (iii) determining a respective sub-layer-level direct-contribution value for each respective attention and MLP sub-layer of the selected deep-learning AI model by calculating a difference between (a) the aggregated sub-layer-level score difference at the sub-layer's output and (b) the aggregated sub-layer-level score difference at the sub-layer's input (which will comprise the aggregated sub-layer-level score difference at the output of the prior sub-layer for all sub-layers except for the first sub-layer that receives the position-encoded embeddings as its input).

In this respect, if the aggregated sub-layer-level score difference at a given sub-layer's output is greater than the aggregated sub-layer-level score difference at the given sub-layer's input such that the sub-layer-level direct-contribution value for the given sub-layer is a value greater than 0, this indicates that the given sub-layer pushes the selected deep-learning AI model to more heavily favor the correct answer than the incorrect answer and thus contributes “positively” to the performance of the selected task. On the other hand, if the aggregated sub-layer-level score difference at a given sub-layer's output is less than the aggregated sub-layer-level score difference at the given sub-layer's input such that the sub-layer-level direct-contribution value for the given sub-layer is a value less than 0, this indicates that the given sub-layer pushes the selected deep-learning AI model to more heavily favor the incorrect answer than the correct answer and thus contributes “negatively” to the performance of the selected task.

To illustrate with an example in the context of a GPT-2 small LLM, which is based on a decoder-only transformer architecture having 12 decoder layers that each comprise a multi-head attention sub-layer and an MLP sub-layer, the computing platform 102 may determine a respective aggregated sub-layer-level score difference at the output of each of the 12 multi-head attention sub-layers and each of the 12 MLP sub-layers (as well as at the input of the first multi-head attention sub-layer based on the position-encoded embeddings), and may then use those values to determine a respective sub-layer-level direct-contribution value for each of the 12 multi-head attention sub-layers and each of the 12 MLP sub-layers—where a positive value indicates that a sub-layer positively contributes to the model's performance of the task and a negative value indicates that a sub-layer negatively contributes to the model's performance of the task.

After the aggregated score difference values and the direct-contribution values are determined for the layers and/or sub-layers of the selected deep-learning AI model in the manner described above, one or both of these sets of values can also be presented in the form of a two-dimensional plot that provides a visualization of how the different layers and/or sub-layers of the selected deep-learning AI model impact its performance of the selected task within the financial services industry. To illustrate with an example, FIG. 6B shows an example two-dimensional plot that provides an example visualization of aggregated score difference values and FIG. 6C shows an example two-dimensional plot that provides a visualization of direct-contribution values for the different sub-layers of a GPT-2 small LLM that has had its behavior evaluated with respect to a selected task of determining whether a consumer interaction involves a fair-lending violation (e.g., based on input questions similar to those shown in FIG. 5A).

In the example two-dimensional plot of FIG. 6B, the x-axis represents the sub-layers of the GPT-2 small LLM, where the number within each x-axis label identifies the layer (0 through 11), “pre” identifies the input to the attention sub-layer of the identified layer (and thus the output of the prior MLP sub-layer except for the first attention sub-layer), “mid” represents the input of the MLP sub-layer of the identified layer (and thus the output of the prior attention sub-layer), and “final_post” represents the output of the MLP sub-layer of the final layer. In turn, the y-axis represents the aggregated logit difference between a correct “yes” answer and an incorrect “no” answer at each identified sub-layer input/output within the GPT-2 small LLM. In this respect, it can be seen that the logit difference generally keeps increasing through the sub-layers of the GPT-2 small LLM (with a few exceptions), which means that each additional sub-layer of the GPT-2 small LLM generally causes the GPT-2 small LLM to favor the correct response more heavily (again, with a few exceptions) and thereby improves the performance of the GPT-2 small LLM for the selected task of determining whether a consumer interaction involves a fair-lending violation.

Further, in the example two-dimensional plot of FIG. 6C, the x-axis represents the sub-layers of the GPT-2 small LLM, where the number within each x-axis label identifies the layer (0 through 11), “attn_out” represents the output of the attention sub-layer of the identified layer, “mlp_out” represents the output of the MLP sub-layer of the identified layer, “post-embed” represents the position-encoded embeddings, and “embed” represents the initial embeddings. In turn, the y-axis represents the sub-layer-level direct-contribution value for each identified sub-layer within the GPT-2 small LLM, which is calculated to be the difference between the aggregated logit difference of the sublayer's output and the sublayer's input. In this respect, it can be seen that the MLP sub-layers of layer 2 and layer 4 have the largest positive contribution to the performance of the GPT-2 small LLM for the selected task of determining whether a consumer interaction involves a fair-lending violation, whereas the MLP sub-layer of layer 10 has the largest negative contribution to the performance of the GPT-2 small LLM for the selected task of determining whether a consumer interaction involves a fair-lending violation.

Turning next to the individual components of the selected deep-learning AI model, the direct attribution technique can also be used to determine the extent of direct contribution of the individual attention heads of the selected deep-learning AI model, and the functionality for determining the extent of direct contribution of the attention heads of the selected deep-learning AI model may include similar functions to those described above for determining the extent of direct contribution of the layers and sub-layers of the selected deep-learning AI model.

For instance, in line with the discussion above, the functionality for determining the extent of direct contribution of the attention heads of the selected deep-learning AI model may involve (i) determining, on a run-by-run basis using the run datasets, a respective head-level score difference (e.g., a logit difference) between the correct-response score value and the incorrect-response score value produced based on the output of each respective attention head of the selected deep-learning AI model, (ii) aggregating each attention head's head-level score difference values across the different runs of the selected deep-learning AI model in order to produce a respective aggregated head-level score difference (e.g., an aggregated head-level logit difference) for each respective attention head of the selected deep-learning AI model, and (iii) determining a respective head-level direct-contribution value for each respective attention head of the selected deep-learning AI model by calculating a difference between (a) the aggregated head-level score difference at the attention head's output and (b) the aggregated head-level score difference at the attention head's input (which will comprise the aggregated layer-level score difference at the output of the prior layer for all attention heads except for those in the first layer that receive the position-encoded embeddings as their input).

In this respect, if the aggregated head-level score difference at a given attention head's output is greater than the aggregated head-level score difference at the given attention head's input such that the head-level direct-contribution value for the given attention head is a value greater than 0, this indicates that the given attention head pushes the selected deep-learning AI model to more heavily favor the correct answer than the incorrect answer and thus contributes “positively” to the performance of the selected task. On the other hand, if the aggregated head-level score difference at a given attention head's output is less than the aggregated head-level score difference at the given attention head's input such that the head-level direct-contribution value for the given attention head is a value less than 0, this indicates that the given attention head pushes the selected deep-learning AI model to more heavily favor the incorrect answer than the correct answer and thus contributes “negatively” to the performance of the selected task.

To illustrate with an example in the context of a GPT-2 small LLM, which is based on a decoder-only transformer architecture having 12 decoder layers that each comprise a multi-head attention sub-layer having 12 individual attention heads, the computing platform 102 may determine a respective aggregated head-level score difference at the output of each of the 144 attention heads, and may then use those values along with the aggregated layer-level score differences (and the aggregated score difference for the position-encoded embeddings) that define the inputs of the attention heads to determine a respective head-level direct-contribution value for each of the 144 attention heads—where a positive value indicates that an attention head positively contributes to the model's performance of the task and a negative value indicates that an attention head negatively contributes to the model's performance of the task.

After the aggregated direct-contribution values are determined for the attention heads of the selected deep-learning AI model in the manner described above, those values can also be presented in the form of a heat map that provides a visualization of how the different attention heads of the selected deep-learning AI model impact its performance of the selected task within the financial services industry. To illustrate with an example, FIG. 6D shows an example heat map that provides a visualization of direct-contribution values for the different attention heads of a GPT-2 small LLM that has had its behavior evaluated with respect to a selected task of determining whether a consumer interaction involves a fair-lending violation (e.g., based on input questions similar to those shown in FIG. 5A).

As shown in FIG. 6D, the example heat map comprises a 12×12 grid of colored cells, where the y-axis of the grid identifies the layer to which each respective cell corresponds (0 through 11) and the x-axis of the grid identifies the attention head within the applicable layer to which each respective cell corresponds (0 through 11). For instance, the cell at 0 on the y-axis and 0 on the x-axis represents the first attention head within the first layer, the cell at 0 on the y-axis and 1 on the x-axis represents the second attention head within the first layer, and so on until the cell at 11 on the y-axis and 11 on the x-axis, which represents the twelfth attention head within the twelfth layer. In connection with this heat map, the convention “L.H” can be used to identify the attention heads where L is the layer number and H is the head number (e.g., 0.0 is the first head in the first layer, 0.1 is the second head in the first layer, and so on). In turn, the coloring of each cell indicates a respective head-level direct-contribution value of the attention head represented by the cell that is calculated as the difference between (i) an aggregated logit-value difference between “yes” and “no” responses at the attention head's output and (ii) an aggregated logit-value difference between “yes” and “no” responses at the attention head's input, where that coloring is defined according to the scale on the right side of the heatmap showing that blue represents a head-level direct-contribution value that is greater than 0 (i.e., a direct-contribution value indicating that the attention head contributes positively to the model's performance of the selected task), white represents a head-level direct-contribution value at or around 0 (i.e., a direct-contribution value indicating that the attention head has a neutral contribution to the model's performance of the selected task), and red represents a head-level direct-contribution value that is less than zero (i.e., a direct-contribution value indicating that the attention head contributes negatively to the model's performance of the selected task).

Based on the example heat map of FIG. 6C, it can be seen that the 6.3, 8.9, and 11.4 attention heads of the GPT-2 small LLM contribute most positively to the LLM's performance of the selected task of determining whether a consumer interaction involves a fair-lending violation, while the 0.6, 10.7, and 11.0 attention heads of the GPT-2 small LLM contribute most negatively to the LLM's performance of the selected task of determining whether a consumer interaction involves a fair-lending violation. The attention patterns of these six attention heads—the three having the highest positive direct-contribution values and the three having the highest negative direct-contribution values—are further shown in FIG. 6E.

The functionality of using the direct attribution technique to determine the extent of direct contribution of the internal aspects of the selected deep-learning AI model to its performance of the selected task within the financial services industry could take other forms as well.

As noted above, the mechanistic interpretability investigation may also involve an activation patching technique, which may generally involve (i) taking certain activations of the selected deep-learning AI model from a “clean” run of the selected task that is designed to cause the selected deep-learning AI model to output a correct response such as “yes” (i.e., a run described in block 308) and patching them into corresponding activations of the selected deep-learning AI model from a “corrupted” run of the selected task that is designed to cause the selected deep-learning AI model to output a different response that was considered to be incorrect during the “clean” run such as “no” (or conversely taking activations from a “corrupted” run and patching them into corresponding activations from a “corrupted” run), and then (ii) evaluating how the different patched-in activations impact the output of the selected deep-learning AI model in order to determine the extent to which different activations contribute to the deep-learning AI model's performance of the selected task. In this respect, the implementation where activations from a “clean” run are patched into a “corrupted” run is referred to as “denoising” and the implementation where activations from a “corrupted” run are patched into a “clear” run is referred to as “noising.” This activation patching functionality can be performed at any of various different points in the selected deep-learning AI model, including at the inputs and/or outputs of layers, attention sub-layers, MLP sub-layers, attention heads, and the component parts of the attention heads (e.g., the key projector, query projector, value projector, and/or attention-pattern generator), among other possibilities.

In an embodiment where the mechanistic interpretability investigation involves activation patching, the defined set of input questions that are designed to cause the selected deep-learning AI model to output a prediction that a particular correct response such as “yes” is substantively more likely than any incorrect response (which are discussed above at block 306) are considered to be the “clean” set of input questions and the runs that are carried out using the clean set of input questions (which are discussed above at block 308) are considered to be the “clean” runs. However, in addition to the clear set of input questions, the dataset corresponding to the selected task that is obtained at block 306 may include another defined set of input questions that are designed to cause the selected deep-learning AI model to output a prediction that a different response considered to be incorrect for the clean set of input questions is substantively more likely than the correct response for the clean set of input questions (e.g., a “no” response instead of a “yes” response)—which are considered the “corrupted” set of input questions.

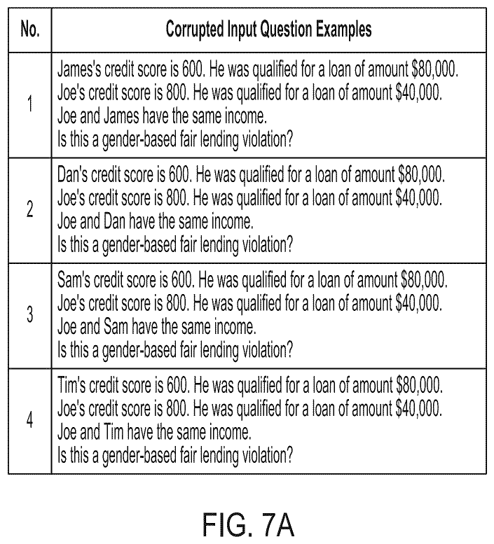

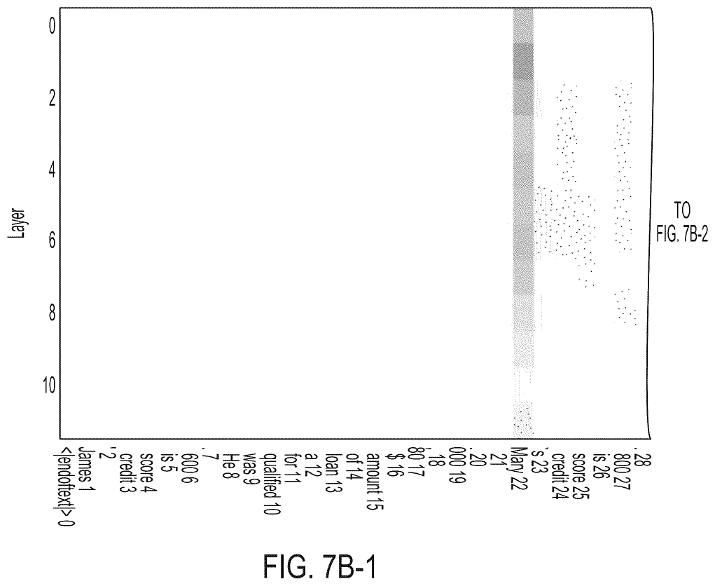

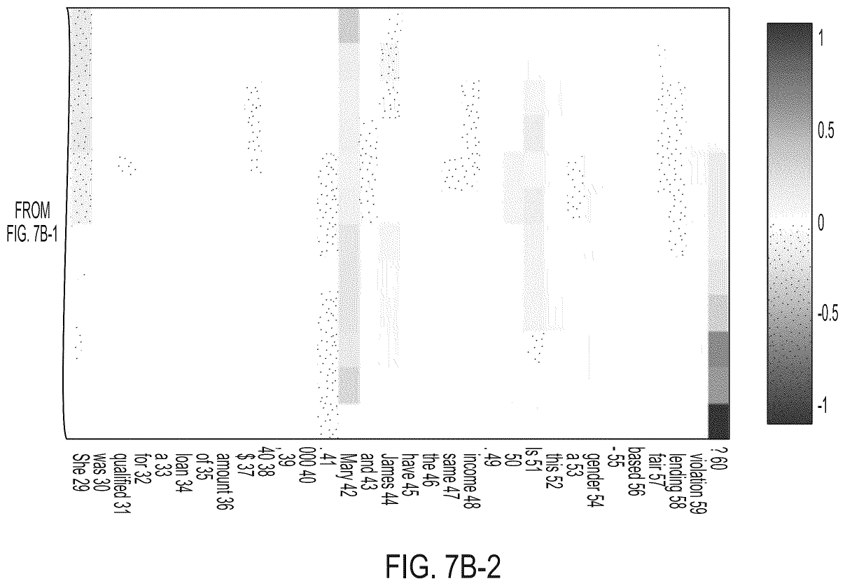

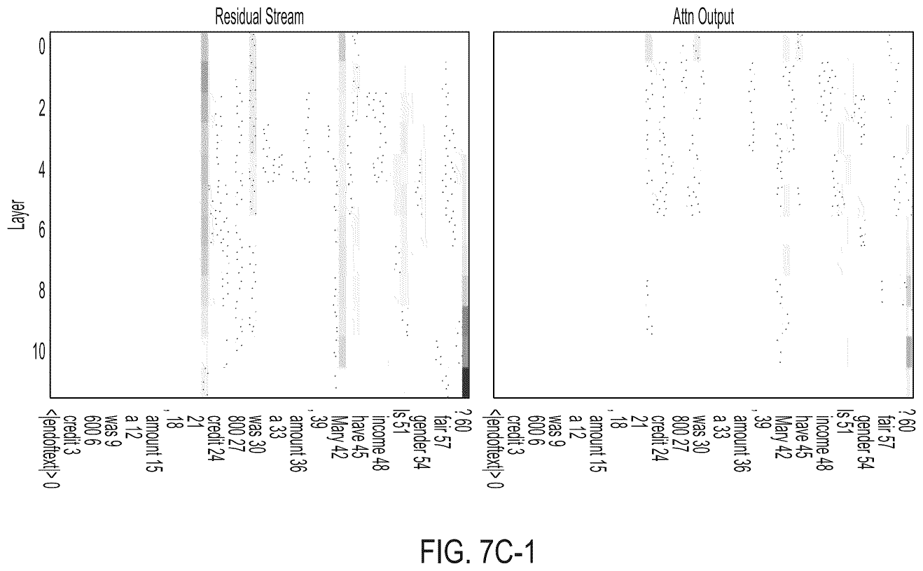

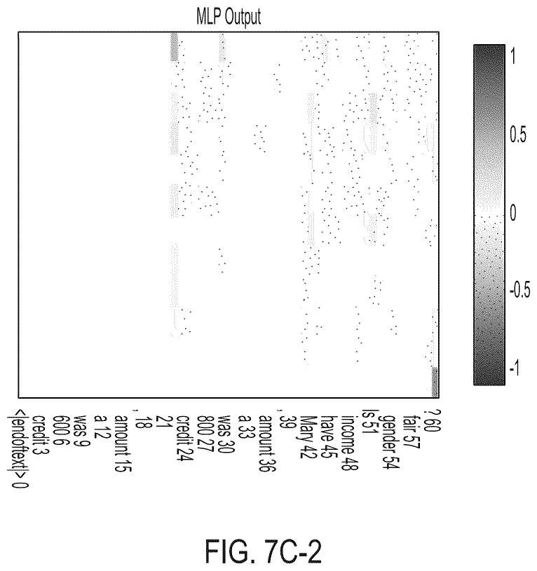

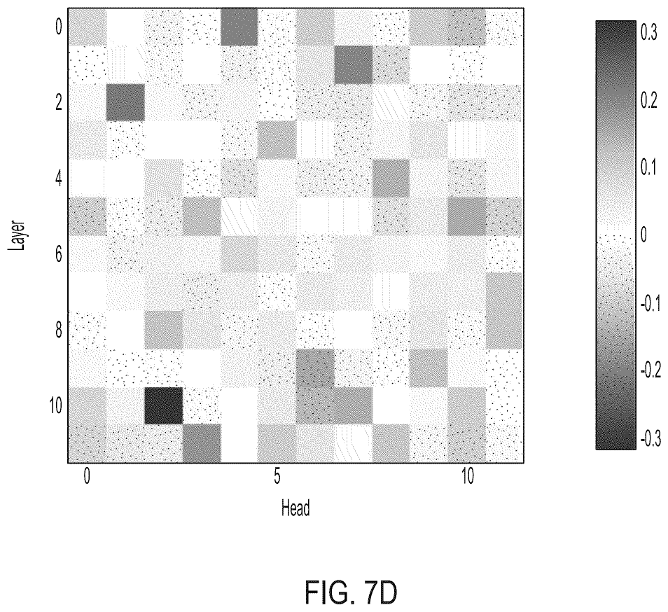

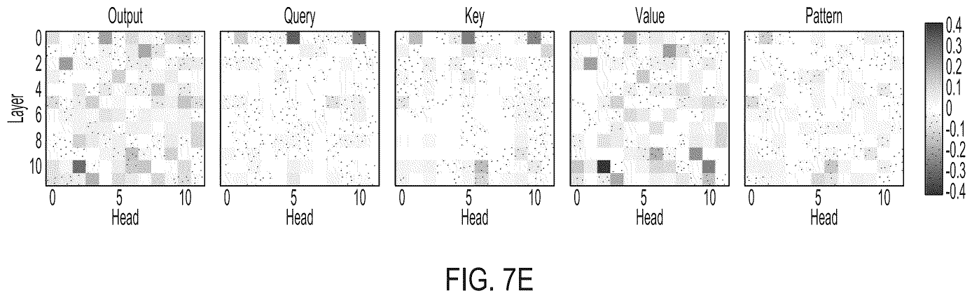

In practice, the corrupted set of input questions may have a similar form to the clean set of input questions, but may have certain of the words within the input questions replaced by other words that are designed to cause the selected deep-leaning AI model's output to flip from favoring the response that was considered to be correct for the clean set of input questions (e.g., a “yes” response) to favoring a different response that was considered to be incorrect for the clean set of questions (e.g., a “no” response). To illustrate with an example, FIG. 7A shows a corrupted set of input questions that correspond to the clean set of input questions that are shown in FIG. 5B. As can be seen in FIG. 7A, the female name of “Mary” from in each input question in the clean set has been replaced with a male name of “Joe,” which is designed to cause the selected deep-leaning AI model's output to flip from (i) predicting that “yes” is the correct response to the input questions regarding a gender-based fair lending violation because they identify scenarios involving an improper bias towards a male over a female to (ii) predicting that “no” is the correct response to the input questions regarding a gender-based fair lending violation because they identify scenarios that involve lending decisions for two males. Many other examples are possible as well.

Further, in practice, the corrupted set of input questions may be obtained in a similar manner to the clean set of input questions. For instance, in one implementation, the function of obtaining the corrupted set of input questions as part of the dataset corresponding to the selected task may involve (i) retrieving one or more “corrupted-run” input templates for the selected task from a data storage layer (e.g., a data storage layer of the computing platform 102) and/or from some other data source that is hosting input templates, where such corrupted-run input templates may have a similar form to the clean-run input templates discussed above except that certain words may be changed to flip the model's response, and (ii) using the one or more corrupted-run input templates to produce the corrupted set of input questions for the selected task. In another implementation, it is possible that the corrupted set of input questions for the selected task are produced in advance based on one or more corrupted-run input templates for the selected task, in which case the function of obtaining the corrupted set of input questions may involve retrieving the corrupted set of input questions for the selected task from a data storage layer (e.g., a data storage layer of the computing platform 102) and/or from some other data source that is hosting the corrupted set of input questions. The function of obtaining corrupted set of input questions may take other forms as well.

The activation patching functionality may then involve running the selected deep-learning AI model using the corrupted set of input questions, where each respective corrupted run of the selected deep-learning AI model involves passing a respective input question from the corrupted set of input questions as input to the selected deep-learning AI model and thereby causing the selected deep-learning AI model to produce a respective output that comprises predicted likelihoods of different responses to the respective input question.

As part of the function of running the selected deep-learning AI model using the corrupted set of input questions, final correct-response and incorrect-response score values (e.g., logit values) as well as intermediate correct-response and incorrect-response score values (e.g., logit values) for the layers, sub-layers, and/or components of the selected deep-learning model may be captured for each corrupted run, where the correct-response score values are for the response that was considered to be incorrect for the clean runs (e.g., a “no” response) and the incorrect-response score values are for the response that was considered to be correct for the clean runs (e.g., a “yes” response). However, for the corrupted runs, the score difference values at the model output as well as the different layers, sub-layers, and/or components may each be determined as the difference between the incorrect-response score value for the corrupted run (which corresponds to the correct-response score value for the clean run) and correct-response score value for the corrupted run (which corresponds to the correct-response score value for the clean run), which means that the score difference values for the corrupted runs will generally be negative values rather than positive values as for the clean runs. To illustrate in the context of a GPT-2 small LLM, the logit-value differences for the final output of the LLM for the four examples of corrupted input questions shown in FIG. 7A may have values of −0.207, −0.101, −0.072, and −0.080 respectively.

After each respective corrupted runs of the selected deep-learning AI model is carried out using the corrupted set of input questions, then for each of various different activations of the selected deep-learning AI model during the respective corrupted run, the computing system 102 may (i) intervene on the activation, (ii) patch the activation with a corresponding activation from a clean run that corresponds to the corrupted run (e.g., a clean run carried out using a clean input question that is paired with the corrupted input question used for the corrupted run), and (iii) evaluate how the patching of the corresponding activation from the clean run impacts the output of the selected deep-learning AI model during the corrupted run. In this respect, as noted above, the computing platform 102 may intervene and patch activations at any of various different points in the selected deep-learning AI model.

For instance, as one possibility, the computing platform 102 may intervene and patch the residual stream at the start of each layer of the selected deep-learning AI model. To illustrate one possible example of this functionality, FIGS. 7B-1 and 7B-2 collectively show an example heat map that provides a visualization of the results of residual stream patching at the onset of the layers of a GPT-2 small LLM that has been used to carry out four corrupted runs using the four examples of corrupted input questions shown in FIG. 7A. As shown in FIGS. 7B-1 and 7B-2, the example heat map comprises a 12×61 grid of colored cells, where the y-axis of the grid identifies the layer to which each respective cell corresponds (0 through 11) and the x-axis of the grid identifies the input token to which each respective cell corresponds (0 through 60). In turn, the coloring of each cell indicates a respective contribution value of the activation represented by the cell that has been averaged across the four corrupted runs, where that coloring is defined according to the scale on the right side of the heatmap showing that blue represents a contribution value that is greater than 0, white represents a contribution value at or around 0, and red represents a contribution value that is less than zero. In this respect, a contribution value closer to 0 means the performance is closer to the one obtained on the corrupted input question, a contribution value closer to 1 means that the performance is closer to that of the clean input question, and a contribution value closer to −1 means that the performance is closer to the opposite of that of the clean input question.

Based on the example heat map of FIGS. 7B-1 and 7B-2, it can be seen that (i) the computation is fairly localized to positions: 22, 29, 42, 44, 54, and END tokens and (ii) the information at token 22 starts to be moved to END token around layers 5 and 6.

As another possibility, the computing platform 102 may intervene and patch the residual stream after the attention and MLP sub-layers of the selected deep-learning AI model in order to determine the causal importance of the attention and MLP sub-layers to the performance of the selected task, which is another way to represent the respective contributions of the attention and MLP sub-layers to the performance of the selected task (although not in terms of the extent of direct contribution as in the direct attribution technique). To illustrate one possible example of this functionality, FIGS. 7C-1 and 7C-2 collectively show a set of three example heap maps that provide a visualization of the results of residual stream patching for a GPT-2 small LLM that has been used to carry out four corrupted runs using the four examples of corrupted input questions shown in FIG. 7A, where (i) the left heat map shows the results of residual stream patching at the onset of the layers of the GPT-2 small LLM, (ii) the middle heat map shows the results of residual stream patching after the attention sub-layers of the GPT-2 small LLM, and (iii) the right heat map shows the results of residual stream patching after the MLP sub-layers of the GPT-2 small LLM. Similar to the example heat map shown in FIGS. 7B-1 and 7B-2, each example heat map shown in FIGS. 7C-1 and 7C-2 comprises grid of colored cells, where the y-axis of the grid identifies the layer to which each respective cell corresponds (0 through 11) and the x-axis of the grid identifies the input token to which each respective cell corresponds. In turn, the coloring of each cell indicates a respective contribution value of the activation represented by the cell that has been averaged across the four corrupted runs, where that coloring is defined according to the scale on the right side of the heatmap showing that blue represents a contribution value that is greater than 0, white represents a contribution value at or around 0, and red represents a contribution value that is less than zero. In this respect, as above, a contribution value closer to 0 means the performance is closer to the one obtained on the corrupted input question, while a contribution value closer to 1 means that the performance is closer to that of the clean input question.

Based on the example heat maps of FIGS. 7C-1 and 7C-2, it can be seen that (i) the attention sub-layers within layers 8 and 10 contribute positively to performance while the attention sub-layer in layer 9 contributes negatively to performance and (ii) the MLP sub-layers in layers 0 and 11 play an important role.

As yet another possibility, the computing platform 102 may intervene and patch in on individual attention heads for all layers and tokens in order to determine the causal importance of the attention heads to the performance of the selected task, which is another way to represent the respective contributions of the attention heads to the performance of the selected task (although not in terms of the extent of direct contribution as in the direct attribution technique). To illustrate one possible example of this functionality, FIG. 7D is an example heat map that provides a visualization of the results of patching in individual attention head outputs for all layers and token positions for a GPT-2 small LLM that has been used to carry out four corrupted runs using the four examples of corrupted input questions shown in FIG. 7A. As shown in FIGS. 7B-1 and 7B-2, the example heat map comprises a 12×12 grid of colored cells, where the y-axis of the grid identifies the layer to which each respective cell corresponds (0 through 11) and the x-axis of the grid identifies the attention head within the applicable layer to which each respective cell corresponds (0 through 11). In turn, the coloring of each cell indicates a respective contribution value of the attention head represented by the cell, where that coloring is defined according to the scale on the right side of the heatmap showing that blue represents a contribution value that is greater than 0, white represents a contribution value at or around 0, and red represents a contribution value that is less than zero.

Based on the example heat map of FIG. 7D, it can be seen that (i) the attention heads 10.2, 10.7, and 11.3, from later layers, and the attention heads 0.4, 1.7, and 2.1, from earlier layers, have very large positive scores, and (ii) the attention heads 9.6 and 10.6, from later layers, and the attention heads 0.10 and 5.0, from earlier layers, have very large negative scores.

As still another possibility, the computing platform 102 may intervene and patch into the intermediate values produced by the attention heads, such as the key vectors, the query vectors, the value vectors, and/or attention patterns, in order to determine the causal importance of the attention heads and/or their decomposed component parts (e.g., the query projector, key projector, value projector, and/or attention-pattern generator) to the performance of the selected task, which is a way to the attention heads and/or their decomposed component parts to the performance of the selected task (although not in terms of the extent of direct contribution as in the direct attribution technique). To illustrate one possible example of this functionality, FIG. 7E is a set of 5 example heat maps that provide a visualization of the results of patching into the intermediate values produced by the attention heads for a GPT-2 small LLM that has been used to carry out four corrupted runs using the four examples of corrupted input questions shown in FIG. 7A, where (i) the first heat map (from left to right) shows the results of patching into the outputs of the GPT-2 small LLM's attention heads, (ii) the second heat map shows the results of patching into the query vectors of the GPT-2 small LLM's attention heads, (iii) the third heat map shows the results of patching into the key vectors of the GPT-2 small LLM's attention heads, (iv) the fourth heat map shows the results of patching into the value vectors of the GPT-2 small LLM's attention heads, and (v) the fifth heat map shows the results of patching into the attention patterns of the GPT-2 small LLM's attention heads. As shown in FIG. 7E, each example heat map comprises a 12×12 grid of colored cells, where the y-axis of the grid identifies the layer to which each respective cell corresponds (0 through 11) and the x-axis of the grid identifies the attention head within the applicable layer to which each respective cell corresponds (0 through 11). In turn, the coloring of each cell indicates a respective contribution value of the attention head represented by the cell, where that coloring is defined according to the scale on the right side of the heatmap showing that blue represents a contribution value that is greater than 0, white represents a contribution value at or around 0, and red represents a contribution value that is less than 0.

Based on the example heat maps of FIG. 7E, it can be seen that (i) some of the layer-0 attention heads such as 0.5, 0.1 and 0.10 are very important because of their query and key projections, the attention head 10.2 is significantly important due to its value projection, (iii) other important attention heads owing to their value projections are 9.6, 9.9, 10.10, 11.3, and 11.10, and (iv) value patching has a more significant effect than key (or query) patching for the important heads in later layers, i.e., layers 9-11.

The functionality of using the activation patching technique to determine the extent of contribution (in terms of causal importance) of the internal aspects of the selected deep-learning AI model to its performance of the selected task within the financial services industry could take other forms as well.

As noted above, the mechanistic interpretability investigation could further involve a path patching technique, which is a more refined version of activation patching that contemplates the alternative of replacing the input to an attention head from another attention head with what it would have been under a different distribution. In other words, path patching involves patching into computational paths between components within the deep-learning AI model and comparing against the original computational paths to determine the causal importance of different computational paths to the selected deep-learning AI model's performance of the selected task, which is yet another way to represent the contribution of internal aspects of the selected deep-learning AI model to its performance of the selected task. For instance, path patching may be utilized to evaluate sequences of computations and how different components of the deep-learning AI model work together to perform the selected task, which may allow for the identification of particular “circuits” within the deep-learning AI model that contribute most positively and/or most negatively to the selected deep-learning AI model's performance of the selected task—where a “circuit” generally refers to a particular subset of components within the deep-learning AI model that work together to perform a specific computation (i.e., a computational subgraph that is responsible for a specific computation). Additionally, path patching can be used to examine how information flows between multiple components of the selected deep-learning AI model, which allows for mapping more complex interaction patterns across the model and how components can work together.

The mechanistic interpretability investigation that is conducted and the mechanistic explanations that are produced by the mechanistic interpretability investigation could take any of various other forms as well, including but not limited to the possibility that the mechanistic interpretability investigation could involve other mechanistic interpretability techniques. Further, as demonstrated above, the mechanistic explanations that are produced by the mechanistic interpretability investigation could take any of various forms.

For instance, in line with the discussion above, the mechanistic explanations that are produced could include any of various different types of contribution values (or sometimes referred to as “importance” values) for the internal aspects of the selected deep-learning AI model, including but not limited to (i) a first type of contribution values produced by a direct attribution technique, (ii) a second type of contribution values produced by an activation patching technique, and/or (iii) a third type of contribution values produced by a path patching technique, among other possibilities.

Further, in line with the discussion above, the mechanistic explanations that are produced could include be at any of various different levels of granularity with respect to the internal aspects of the selected deep-learning AI model, including but not limited to (i) layer-level contribution values that indicate the respective contributions of different encoder and/or decoder layers of the selected deep-learning AI model, (ii) sub-layer-level contribution values that indicate the respective contributions of different multi-head attention and/or MLP sub-layers of the selected deep-learning AI model, (iii) computational-subgraph-level contribution values that indicate the respective contributions of different computational subgraphs (e.g., circuits) within the selected deep-learning AI model, (iv) attention-head-level contribution values that indicate the respective contributions of different attention heads within the selected deep-learning AI model, and/or (v) head-part-level contribution values that indicate the respective contributions of different component parts of the attention heads within the selected deep-learning AI model, among other possibilities. Along similar lines, the identifications of which aspects of the deep-learning AI model contribute most positively and/or most negatively to the selected deep-learning AI model's performance of the selected task could likewise be based on any of various different types of contribution values and could be at any of various different levels of granularity with respect to the internal aspects of the selected deep-learning AI model.

The functionality of the disclosed technological framework could take various other forms as well, including but not limited to the possibility that certain of the functionality of FIG. 3 could be performed in a different order or could be performed in parallel, among other possibilities.

The mechanistic explanations produced by the disclosed technological framework that is described with reference to FIG. 3—which as noted above may include (i) contribution values for different aspects of a deep-learning AI model (e.g., different layers, sub-layers, computational subgraphs, components such as attention heads, sub-components such as an attention head's component parts, etc.) that indicate the extent to which the different aspects of the deep-learning AI model contribute to its performance of the selected task within the financial services industry and/or (ii) identifications of which aspects of the deep-learning AI model contribute most positively and/or most negatively to the selected deep-learning AI model's performance of the selected task—may be utilized for various purposes.

For instance, as one possibility, the mechanistic explanations for the deep-learning AI model's behavior (e.g., the contribution values and/or identified aspects of the deep-learning AI model) that are produced by the disclosed framework may be presented to individuals involved in the process of creating, overseeing, and/or evaluating the performance of the deep-learning AI model to assist in those tasks, who may then use the mechanistic explanations for the deep-learning AI model's behavior to help understand why the deep-learning AI model outputs the predictions that it does for the given task. This may allow such individuals to validate that deep-learning AI model meets certain standards of performance (e.g., in terms of reliability, fairness, security, etc.) such that it can be utilized to perform the given task in production without presenting concerns of safety, societal risks, or the like.

As another possibility, the mechanistic explanations for the deep-learning AI model's behavior (e.g., the contribution values and/or identified aspects of the deep-learning AI model) that are produced by the disclosed framework may be utilized to guide the future editing of the deep-learning AI model. For example, based on the mechanistic explanations for the deep-learning AI model's behavior, the deep-learning AI model could be edited to reinforce the aspects of the deep-learning AI model that are identified as contributing most positively to the deep-learning AI model's performance of the given task and/or to suppress the aspects of the deep-learning AI model that are identified as contributing most positively to the deep-learning AI model's performance of the given task.

As yet another possibility, the mechanistic explanations for the deep-learning AI model's behavior (e.g., the contribution values and/or identified aspects of the deep-learning AI model) that are produced by the disclosed framework may be utilized to help explain certain training phenomena such as grokking and memorization.

As still another possibility, the mechanistic explanations for the deep-learning AI model's behavior (e.g., the contribution values and/or identified aspects of the deep-learning AI model) that are produced by the disclosed framework may be utilized as a basis for improving the efficiency of the deep-learning AI model, such as by using the mechanistic explanations to help guide a process for reducing the size, prediction time (or sometimes referred to as “inference time”), resource consumption, and/or compute cost of the deep-learning AI model.

The mechanistic explanations for the deep-learning AI model's behavior that are produced by the disclosed framework may be utilized for other purposes as well, such as improving model reliability and/or mitigating model bias.

One particular approach for improving the efficiency of a deep-learning AI model is “quantization.” As noted above, a deep-learning AI model may be comprised of many different individual components and layers that are interconnected together, and those components and layers may collectively be configured to utilize millions, billions, or even trillions of different parameters. Due to the large number of parameters included in a deep-learning AI model, the operations of training, storing, and executing a deep-learning AI model typically require a significant extent of storage capacity (e.g., HDD, SDD, etc.), memory capacity (e.g., VRAM, RAM, etc.), and computational power. For instance, a deep-learning AI model has a storage footprint that often ranges from several gigabytes (GBs) to hundreds of GBs (e.g., up to 700 GBs or more), and the training and execution of a deep-learning AI model often requires the use of multiple high-power, high-memory graphics processing units (GPUs), which may lead to increased energy consumption and increased cost. Moreover, the numerical parameters included in a deep-learning AI model typically have a higher precision such as 64-bit precision (e.g., FP 64), 32-bit precision (e.g., FP32), or 16-bit precision (e.g., FP16), which further contributes to the large extent of storage capacity, memory capacity, and computation power required by a deep-learning AI model and may also degrade the prediction time of the deep-learning AI model when it is executed on certain computing platforms, because higher-precision parameters slow down the computational operations performed by the deep-learning AI model as well as increase the memory utilization of the deep-learning AI model.

For these and other reasons, there is often a practical limitation on which computing platforms can be utilized to train, store, and execute a deep-learning AI model, which may constrain the usefulness and value of the deep-learning AI model. For example, due to the number and/or precision of the parameters included in at least some types of deep-learning AI models, it may be difficult or impossible to store and execute such deep-learning models on “edge” computing platforms such as end-user devices (e.g., a smartphone, tablet, a wearable, etc.), smart home devices (e.g., a smart camera), Internet-of-Things (IoT) devices, and/or on-board computing platforms of vehicles, aircrafts, drones, or the like, among other possible types of edge computing platforms. However, this inability to store and execute certain types of deep-learning AI models on edge computing platforms is problematic, because edge computing platforms tend to offer a number of other benefits over cloud-based or on-premise computing platforms, including improved responsiveness, enhanced security and privacy, offline capabilities, and reduced network bandwidth consumption.

Quantization attempts to address the foregoing problems with deep-learning AI models by reducing the precision of the numerical parameters of the deep-learning AI model, which thereby helps to reduce both (i) the compute resources (e.g., storage capacity, memory capacity, computational power, etc.) required to store and execute deep-learning AI model and (ii) the prediction time of the deep-learning AI model. In this respect, quantization of a deep-learning AI model may provide various benefits, including reducing the cost of storing and executing the deep-learning AI model, decreasing the prediction time of the deep-learning AI model, and enabling the deep-learning AI model to be stored and executed on a wider range of computing platforms including but not limited to edge computing platforms. However, the primary tradeoff for these advantages is that reducing the precision of the numerical parameters of the deep-learning AI model tends to degrade the predictive accuracy of the deep-learning AI model, which is due to a variety of factors including that decreased precision may lead to loss in data fidelity, saturation errors, rounding errors, and/or reduced expressiveness of the deep-learning AI model, among others.

Given the continued adoption of deep-learning AI models and the aforementioned benefits of performing quantization of deep-learning AI models, there has been a recent emergence of quantization technology that is intended to reduce the precision of a deep-learning AI model's numerical parameters while also attempting to preserve the predictive accuracy of the deep-learning AI model. Such existing quantization technology includes post-training quantization (PTQ) technology that is applied after a deep-learning AI model has been trained using full-precision numerical parameters (e.g., uniform PTQ, activation-aware weight quantization (AWQ), etc.) and quantization-aware training (QAT) technology that is performed while a deep-learning AI model is being trained or fine-tuned (e.g., uniform QAT, quantized low-rank adaptation (QLoRa), etc.), among other possibilities. Further, such existing quantization technology may work with various different levels of precision, such as a full, higher precision of either 64-bit precision (e.g., FP64), 32-bit precision (e.g., FP32) or 16-bit precision (e.g., FP16) and a reduced, lower precision of either 8-bit precision (e.g., int8), 4-bit precision (e.g., int4), or perhaps even 2-bit or 1-bit precision, among various other possibilities. Further yet, certain existing quantization technology may utilize the same reduced precision level for all numerical parameters of a deep-learning AI model while other certain existing quantization technology may utilize different precision levels for different numerical parameters of a deep-learning AI model (e.g., one precision level for numerical parameters related to the multi-head attention sub-layers and another precision level for numerical parameters related to the MLP sub-layers).

However, there remains a need for quantization technology that is capable of reducing the numerical precision of the parameters of the deep-learning AI model in a way that intelligently balances between achieving the foregoing benefits of quantization and preserving the predictive accuracy of the deep-learning AI model.

To address this need, disclosed herein is improved quantization technology that utilizes mechanistic explanations for a deep-learning AI model's performance of a particular task—such as the mechanistic explanations produced by the disclosed framework discussed above (e.g., the contribution values and/or identified aspects of the deep-learning AI model)—as a basis for performing quantization of the deep-learning AI model in a more intelligent way. At a high level, the quantization technology may involve (i) producing multiple candidate quantized versions of the deep-learning AI model that differ from one another with respect to one or both of (a) the particular space of numerical parameters that are to have their precision frozen during quantization (referred to herein as the “frozen-parameter space”), which is determined based on the mechanistic explanations for the deep-learning AI model's performance of the particular task, and/or (b) the particular reduced precision level to which the remaining space of numerical parameters (referred to herein as the “unfrozen-parameter space”) are quantized, (ii) selecting a given one of the multiple candidate quantized versions of the deep-learning AI model as a final quantized version of the deep-learning AI model that is to be deployed in place of the original version of the deep-learning AI model, and (iii) causing the final quantized version of the deep-learning AI model to be deployed.

Thus, by utilizing mechanistic explanations for a deep-learning AI model's performance of a particular task in order to guide the quantization process, the disclosed quantization technology produces a quantized version of the deep-learning AI model that has a smaller storage and memory footprint, requires less computational resources to run, and may also have reduced prediction time while still maintaining predictive accuracy that is comparable to the original version of the deep-learning AI model when being used to perform the particular task. In this way, the disclosed quantization technology achieves an improved balancing of these factors relative to existing quantization technology. For instance, when comparing a quantized version of a deep-learning AI model that is produced by the disclosed quantization technology to another quantized version of the same deep-learning AI model produced by the existing quantization technology that has a comparable storage and memory footprint and comparable computational requirements, the quantized version produced by the disclosed quantization technology will typically provide improved predictive accuracy. Likewise, when comparing a quantized version of a deep-learning AI model that is produced by the disclosed quantization technology to another quantized version of the same deep-learning AI model produced by the existing quantization technology that provides comparable predictive accuracy, the quantized version produced by the disclosed quantization technology will typically have a reduced storage and memory footprint and reduced computational requirements. These improvements are due to the disclosed quantization technology's intelligent approach for reducing the precision of the deep-learning AI model's numerical parameters.

As a result, the disclosed quantization technology may be utilized to produce a quantized version of a deep-learning AI model that can be run on an edge computing platform—which allows for all of the benefits of edge computing discussed above—while still providing predictive accuracy that is comparable to the original version of the deep-learning AI model when performing the particular task for which the mechanistic interpretability investigation was conducted (e.g., a task within the financial services industry).

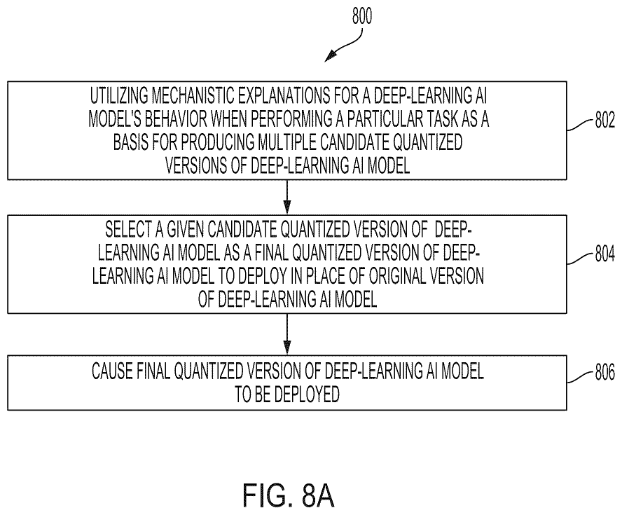

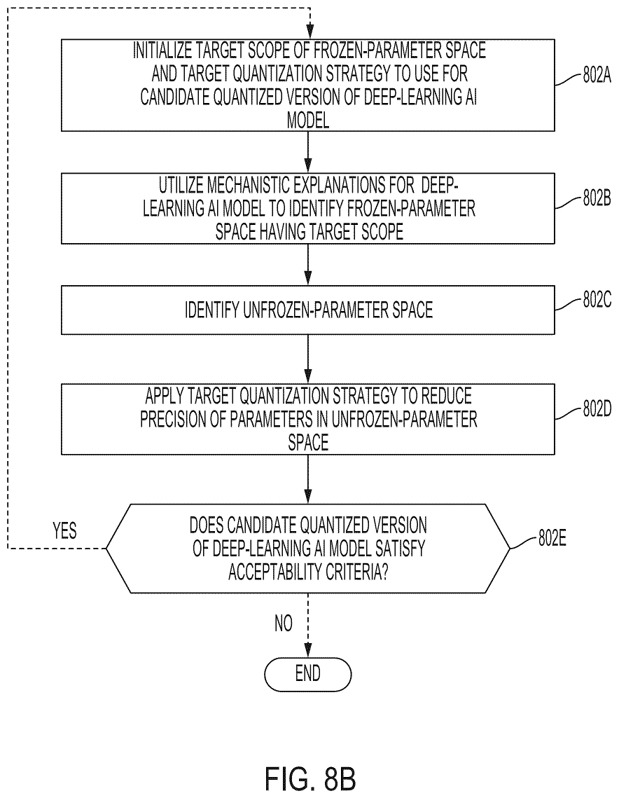

One possible example of functionality 800 for utilizing mechanistic explanations for a deep-learning AI model to perform quantization of the deep-learning AI model will now be described with reference to the flow charts of FIGS. 8A-8B. In practice, the functionality 800 of FIGS. 8A-8B may be encoded in the form of program instructions that are executable by one or more processors of a computing platform, and for purposes of illustration, the functionality 800 of FIGS. 8A-8B is described as being carried out by the computing platform 102 of FIG. 1, but it should be understood that the functionality 800 of FIGS. 8A-8B may be carried out by any one or more computing platforms that are capable of performing the example functions described herein. Further, it should be understood that the functionality 800 of FIGS. 8A-8B is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

As shown in FIG. 8A, the example functionality 800 may begin at block 802 with the computing platform 102 utilizing mechanistic explanations for a deep-learning AI model's behavior when performing a particular task as a basis for producing multiple candidate quantized versions of the deep-learning AI model, where each such candidate quantized version of the deep-learning AI model differs from the other candidate quantized versions of the deep-learning AI model with respect to one or both of (i) the particular space of numerical parameters that are to have their precision frozen during quantization (i.e., the “frozen-parameter space”) and/or (ii) the particular quantization strategy utilized to reduce the precision level of the remaining space of numerical parameters (i.e., the “unfrozen-parameter space”). In this respect, the functionality for producing the candidate quantized versions of the deep-learning AI model may take any of various forms, and one possible example of functionality for producing a candidate quantized version of the deep-learning AI model is described below with reference to FIG. 8B.

In operation, the computing platform 102 may carry out multiple iterations of the functionality of FIG. 8B in order to produce multiple candidate quantized versions of the deep-learning AI model, where each such iteration may involve a different combination of values for the scope of the frozen-parameter space and the quantization strategy utilized to reduce the precision level of the unfrozen-parameter space—which may be viewed as two possible dimensions for defining the specific quantization to be applied to the deep-learning AI model (i.e., the “quantization dimensions”). In this respect, the possible values for the scope of the frozen-parameter space and the quantization strategy for reducing the precision level of the unfrozen-parameter space may be defined in any of various manners.

Beginning with the scope of the frozen-parameter space, as one possibility, the possible values could be defined in terms of certain percentages of the total number of model parameters or certain counts of frozen parameters. As an example to illustrate, the possible values for the scope of the frozen-parameter space could comprise percentages of the total number of parameters in the deep-learning AI model that range from 1% to ~75%, among other possible values.

As another possibility, the possible values for the scope of the frozen-parameter space could be defined in terms of the type and number of different aspects of the deep-learning AI model can be selected to have their associated parameters frozen, which may depend on both the configuration of the deep-learning AI model and the granularity of the available mechanistic explanations, among other possible factors. In this respect, the possible values for the scope of the frozen-parameter space could be defined in terms of different possible numbers of layers, multi-head attention sub-layers, MLP sub-layers, attention heads, attention-head parts, and/or combinations thereof (e.g. computational subgraphs such as circuits) that may be selected to have their associated parameters frozen, among other internal aspects of the deep-learning AI model that can be selected to have their associated parameters frozen. As one example to illustrate, if the most granular mechanistic explanations that are available for the deep-learning AI model are sub-layer-level contribution values, then the possible values for the scope of the frozen-parameter space may be defined in terms of different possible numbers of multi-head attention sub-layers and MLP sub-layers that may be selected to have their parameters frozen (e.g., a first scope comprising 1 frozen attention multi-head sub-layer and 0 frozen MLP sub-layers, a second scope comprising 0 frozen multi-head attention sub-layers and 1 frozen MLP sub-layers, a third scope comprising 1 frozen multi-head attention sub-layer and 1 frozen MLP sub-layer, and so on until a scope that corresponds to a maximum number of multi-head attention sub-layers and MLP sub-layers that can be selected to have their parameters frozen). As another example to illustrate, if the most granular mechanistic explanations that are available for the deep-learning AI model are attention-head-level contribution values, then the possible values for the scope of the frozen-parameter space may be defined in terms of both different possible numbers of attention sub-layers and MLP sub-layers that may be selected to have their parameters frozen and different possible numbers of individual attention heads that may be selected to have their parameters frozen. Many other examples are possible as well.

Based on the foregoing, it will be appreciated that the possible values for the scope of the frozen-parameter space can be represented in terms of how many layers, sub-layers, components, sub-components, and/or combinations thereof (e.g., computational subgraphs such as circuits that may be at varying levels of granularity) of the deep-learning AI model are to have their parameters frozen during a given iteration, rather than how many individual numerical parameters of the deep-learning AI model are to be frozen during the given iteration. And relatedly, when the possible values for the scope of the frozen-parameter space are represented in this way, it will be appreciated that the scope of the frozen-parameter space could have multiple different values that could ultimately map to a very similar number of parameters. To illustrate with a simple example, it is possible that the scope of the frozen-parameter space could have (i) a first value that is represented as 1 decoder layer and (ii) a second value that is represented as 1 multi-head attention sub-layer and 1 MLP sub-layer. In such an example, these two values for the scope of the frozen-parameter space may correspond to similar numbers of parameters because each layer's parameters are primarily comprised of the parameters of its multi-head attention and MLP sub-layers. However, for purposes of the iterations discussed herein, these two values may be treated as different scopes of the frozen-parameter space, as they may result the identification of different frozen-parameter spaces given that the 1 multi-head attention sub-layer and the MLP sub-layer that are selected based on the mechanistic explanations may come from different decoder layers.

The possible values for the scope of the frozen-parameter space could be defined in other manners and/or take other forms as well.

Turning next to the quantization strategy for reducing the precision level of the unfrozen-parameter space, as one possibility, the possible values could be defined in terms of the reduced precision level to which the unfrozen-parameter space is to be quantized. As an example to illustrate, the possible values for the quantization strategy could comprise reduced precision levels of FP32 (if the full precision level is FP64), FP16, int8, int4, int3, or int2, among other possible values. In this respect, the particular values that are utilized for the reduced precision level could depend on factors such as the full precision level of the deep-learning AI model's parameters and/or information about a target size of the quantized version of the deep-learning AI model, among other possible factors.

The possible values of the quantization strategy for reducing the precision level of the unfrozen-parameter space may be defined in other various manners and/or take other forms as well. For instance, in addition to the reduced precision level, the possible values of the quantization strategy for reducing the precision level of the unfrozen-parameter space could also be defined in terms of the particular quantization technique that is utilized to quantize the unfrozen-parameter space to the reduced precision level (i.e., a quantization strategy could be defined in terms of a combination of (i) reduced precision level and (ii) quantization technique). However, for purposes of illustration and explanation, the possible values of the quantization strategy for reducing the precision level of the unfrozen-parameter space are primarily described below in terms of different reduced precision levels.

Further, the manner in which the computing platform 102 carries out the different iterations of the functionality of FIG. 8B using the different combinations of values for the quantization dimensions in order to produce multiple candidate quantized versions of the deep-learning AI model may take various different forms.

As one possibility, the computing platform 102 may be configured to cycle through different iterations of the functionality of FIG. 8B in a sequential manner whereby the computing platform 102 (i) utilizes an initial combination of values for quantization dimensions during the first iteration of the functionality of FIG. 8B (e.g., a most-conversative combination of values the two quantization dimensions), and then (ii) for each subsequent iteration in the sequence, utilizes an updated combination of values for the quantization dimensions relative to the combination of values utilized for the prior iteration (e.g. incrementally-more-aggressive value for one or both of the two quantization dimensions). Such a sequential approach for carrying out iterations of the functionality of FIG. 8B may take any of various forms.

For instance, one possible implementation of such a sequential approach for carrying out iterations of the functionality of FIG. 8B may involve a single-level iterative approach that treats the combination of the two quantization dimensions (i.e., the scope of the frozen-parameter space and the quantization strategy for reducing the precision level of the unfrozen-parameter space) as a single looping variable and loops over different possible value combinations for the two quantization dimensions—where each respective value combination that is utilized may differ from the prior value combination with respect to one or both of the two quantization dimensions. And in this implementation, the computing platform 102 may continue to initiate new iterations of the functionality of FIG. 8B until either (i) a stopping condition for the loop is reached (to the extent that a stopping condition for the loop has been put into place), or (ii) all possible values combinations for the two quantization dimensions have been utilized.

To illustrate with an example, such a single-level iteration approach may involve (i) carrying out a first iteration of the functionality of FIG. 8B for producing a candidate quantized version of the deep-learning AI model that utilizes a largest possible scope of the frozen-parameter space that may be selected based on the mechanistic explanations (e.g., ~75% of the total number of parameters in the deep-learning AI model) and a quantization strategy with a highest possible reduced precision level (e.g., FP16), which represents a most-conservative combination of values for the quantization dimensions, and then (ii) during each subsequent iteration of the functionality of FIG. 8B, utilize either an incrementally-smaller scope of the frozen-parameter space or a quantization strategy with an incrementally-lower reduced precision level (e.g., on an alternating or semi-alternating basis) in order to more aggressively quantize the deep-learning AI model relative to the prior iteration—where the computing platform 102 may continue to initiate new iterations of the functionality of FIG. 8B until either (i) a given iteration of the functionality of FIG. 8B results in a determination that the candidate quantized version of the deep-learning AI model being produced does not satisfy acceptability criteria, which may serve as a stopping condition for the loop, or (ii) all possible values combinations for the two quantization dimensions have been utilized.

Another possible implementation of such a sequential approach for carrying out iterations of the functionality of FIG. 8B may involve a nested two-level iterative approach that loops over possible values for a first one of the two quantization dimensions (i.e., either the scope of the frozen-parameter space or quantization strategy for reducing the precision level of the unfrozen-parameter space), and for each such value of the first quantization dimension, loops over possible values for a second one of the two quantization dimension. In this respect, the loop for the first quantization dimension may be referred to as the “outer” loop, and the loops for the second quantization dimension may be referred to as “inner” loops or “sub-loops.”

To illustrate with a first example where the scope of the frozen-parameter space is the first dimension and the quantization strategy for reducing the precision level of the unfrozen-parameter space is the second dimension, such a nested two-level iteration approach may begin with a first inner loop of iterations of the functionality of FIG. 8B that all utilize a first frozen-parameter space having a first scope (e.g., a largest possible scope of the frozen-parameter space such as ~75% of the total number of parameters in the deep-learning AI model) but utilize different values for the reduced precision level of the quantization strategy, where (i) a first iteration of the first inner loop utilizes a highest possible reduced precision level of the quantization strategy (e.g., FP16), (ii) each subsequent iteration in the first inner loop utilizes an incrementally-lower reduced precision level of the quantization strategy (e.g., int8, int4, etc.), and (iii) the first inner loop terminates when either a given iteration of the functionality of FIG. 8B results in a determination that the candidate quantized version of the deep-learning AI model being produced does not satisfy acceptability criteria or the lowest possible reduced precision level of the quantization strategy has been reached. In turn, the nested two-level iteration approach may proceed to a second inner loop of iterations of the functionality of FIG. 8B that all utilize a second frozen-parameter space having a second scope (e.g., a scope that is incrementally smaller and thus more aggressive than the first scope of the first frozen-parameter space) but utilize different values for the reduced precision level of the quantization strategy, a third inner loop of iterations of the functionality of FIG. 8B that all utilize a third frozen-parameter space having a third scope (e.g., a scope that is incrementally smaller and thus more aggressive than the second scope of the first frozen-parameter space) but utilize different values for the reduced precision level of the quantization strategy, and so on until either a stopping condition is reached with respect to the outer loop or all possible values of the scope of the frozen-parameter space are utilized.

Likewise, to illustrate with a second example where the quantization strategy for reducing the precision level of the unfrozen-parameter space is the first parameter and the scope of the frozen-parameter space is the second parameter, such a nested two-level iteration approach may begin with a first inner loop of iterations of the functionality of FIG. 8B that all utilize a quantization strategy with a first reduced precision level (e.g., a largest possible reduced precision level such as FP16) but utilize different values for the scope of the frozen-parameter space, where (i) a first iteration of the first inner loop utilizes a frozen-parameter space having a largest possible scope (e.g., ~75% of the total number of parameters in the deep-learning AI model), (ii) each subsequent iteration in the first inner loop utilizes an incrementally-smaller frozen-parameter space, and (iii) the first inner loop terminates when either a given iteration of the functionality of FIG. 8B results in a determination that the candidate quantized version of the deep-learning AI model being produced does not satisfy acceptability criteria or the smallest possible frozen-parameter space has been reached. In turn, the nested two-level iteration approach may proceed to a second inner loop of iterations of the functionality of FIG. 8B that all utilize a quantization strategy with a second reduced precision level (e.g., a reduced precision level is incrementally lower and thus more aggressive than the first reduced precision level) but utilize different values for the scope of the frozen-parameter space, a third inner loop of iterations of the functionality of FIG. 8B that all utilize a quantization strategy with a third reduced precision level (e.g., a reduced precision level is incrementally lower and thus more aggressive than the second reduced precision level) but utilize different values for the scope of the frozen-parameter space, and so on until either a stopping condition is reached with respect to the outer loop or all possible values of the reduced precision level are utilized.

The process of cycling through different iterations of the functionality of FIG. 8B for producing a candidate quantized version of the deep-learning AI model in a sequential manner may take various other forms as well, including but not limited to the possibility that the process may not have any stopping condition that causes a loop to terminate prior to the exhaustion of the possible values for the two quantization dimensions and/or that the process may have multiple different types of stopping conditions that could cause a loop to terminate prior to the exhaustion of the possible values for the two quantization dimensions.

As another possibility, the computing platform 102 may be configured to carry out the different iterations of the functionality of FIG. 8B for producing a candidate quantized version of the deep-learning AI model in a parallel (or at least semi-parallel) manner rather than in a sequential manner. For instance, the computing platform 102 may start by defining a set of possible value combinations for the two quantization dimensions (i.e., the scope of the frozen-parameter space and the quantization strategy for reducing the precision level of the unfrozen-parameter space), and may then carry out the functionality of FIG. 8B utilizing each possible combination of values for the two quantization dimensions in a parallel (or at least semi-parallel) rather than in a sequential manner.

The manner in which the computing platform 102 carries out the different iterations of the functionality of FIG. 8B in order to produce multiple candidate quantized versions of the deep-learning AI model may take other forms as well.

Turning now to the example functionality for producing one particular candidate quantized version of the deep-learning AI model, as shown in FIG. 8B, such functionality may begin at block 802A with the computing platform 102 initializing a target scope of the frozen-parameter space and a target quantization strategy to utilize for producing this candidate quantized version of the deep-learning AI model. In this respect, the target scope of the frozen-parameter space and the target quantization strategy for reducing the precision of the unfrozen-parameter space may be selected based on the iterative approach being employed and the current iteration's position within the overall set of iterations to be carried out, among other possibilities.

For instance, if a sequential iterative approach is being employed, then the target scope of the frozen-parameter space and the target reduced quantization strategy for reducing the precision of the unfrozen-parameter space may be selected based on the values of those two quantization dimensions that were utilized for the prior iteration of the functionality of FIG. 8B, and more particularly, either (i) the scope of the frozen-parameter space may be change (e.g., incrementally narrowed) relative to the scope of the frozen-parameter space used for the prior iteration or (ii) the reduced precision level of the quantization strategy for reducing the precision of the unfrozen-parameter space may be changed (e.g., incrementally decreased) relative to the reduced precision level of the quantization strategy used for the prior iteration.

Alternatively, if a parallel (or semi-parallel) iterative approach is being employed, then the target scope of the frozen-parameter space and the target quantization strategy for reducing the precision of the unfrozen-parameter space may be selected from a defined set of possible value combinations for the two quantization dimensions (where value combinations already selected for other iterations are not eligible for selection).

The target scope of the frozen-parameter space and the target quantization strategy for the candidate quantized version of the deep-learning AI model may be selected in various manners as well.

Further, in line with the discussion above, the target scope of the frozen-parameter space and the target quantization strategy that are selected and initialized for the candidate quantized version of the deep-learning AI model may have any of various values, including but not limited to any of the types of values discussed above.

For example, the target scope of the frozen-parameter space could be represented in terms of a percentage of a total number of parameters of the deep-learning AI model, a count of parameters to be frozen, or counts of different types of internal aspects of the deep-learning AI model (e.g., layers, sub-layers, components such as attention heads, sub-components such as attention-head parts, and/or computational subgraphs such as circuits) that are to have their associated parameters frozen, and the target quantization strategy could be represented in terms of a particular reduced precision level such as FP16, int8, int4, or the like, among various other possible examples.

The function of initializing the target scope of the frozen-parameter space and the target quantization strategy to utilize for producing this candidate quantized version of the deep-learning AI model may take various other forms as well.

At block 802B, the computing platform 102 may utilize the mechanistic explanations for the deep-learning AI model as a basis for identifying a frozen-parameter space having the target scope for this candidate quantized version of the deep-learning AI model. This functionality may take various forms.

In at least some implementations, this function may begin with the computing platform 102 utilizing the mechanistic explanations for the deep-learning AI model to select certain internal aspects of the deep-learning AI model that are to have their associated parameters frozen (e.g., internal aspects of the deep-learning AI model that are most important to the performance of the particular task), which may depend in part on the type and/or granularity of the mechanistic explanations that are available for the deep-learning AI model.

As a first possible scenario, if the mechanistic explanations that are available for the deep-learning AI model include layer-level contribution values (e.g., layer-level contribution values produced by a direct attribution technique and/or an activation patching technique), then the computing platform 102 may (i) utilize such layer-level contribution values to rank the layers of the deep-learning AI model in order of how much they positively contribute to the deep-learning AI model's performance of the particular task (e.g., based on a single type of layer-level contribution values or perhaps multiple different types of layer-level contribution values that are combined together in some way), and then (ii) select a given number of the layers that are to have their parameters frozen by starting with the top-most layer in the ranking (i.e., the layer having the largest positive contribution) and then proceeding down the ranking of the layers until the given number of layers has been selected—where that given number corresponds to the target scope of the frozen-parameter space for this candidate quantized version of the deep-learning AI model. To illustrate with an example that is in the context of a GPT-2 small LLM, which is based on a decoder-only transformer architecture having 12 decoder layers, the computing platform 102 may rank the 12 decoder layers in order of how much they positively contribute to the deep-learning AI model's performance of the particular task and then select some number of decoder layers from the top of the ranking (e.g., the top 1, top 2, top 3, etc.).

As a second possible scenario, if the mechanistic explanations that are available for the deep-learning AI model include sub-layer-level contribution values (e.g., sub-layer-level contribution values produced by a direct attribution technique and/or an activation patching technique), then the computing platform 102 may (i) utilize such sub-layer-level contribution values to rank the sub-layers of the deep-learning AI model in order of how much they positively contribute to the deep-learning AI model's performance of the particular task (e.g., based on a single type of sub-layer-level contribution values or perhaps multiple different types of sub-layer-level contribution values that are combined together in some way), and then (ii) select a given number of the sub-layers that are to have their parameters frozen by starting with the top-most sub-layer in the ranking (i.e., the sub-layer having the largest positive contribution) and then proceeding down the ranking of the sub-layers until the given number of sub-layers has been selected—where that given number corresponds to the target scope of the frozen-parameter space for this candidate quantized version of the deep-learning AI model. In this respect, the computing platform 102 may perform this ranking and selection collectively across both the multi-head attention sub-layers and the MLP sub-layers, or may perform this ranking and selection separately for the multi-head attention sub-layers and for the MLP sub-layers. To illustrate with an example that is in the context of a GPT-2 small LLM, which is based on a decoder-only transformer architecture having 12 multi-head attention sub-layers and 12 MLP sub-layers, the computing platform 102 may rank the 24 total sub-layers in order of how much they positively contribute to the deep-learning AI model's performance of the particular task and then select some number of sub-layers from the top of the ranking (e.g., the top 3, top 5, etc.).

As a third possible scenario, if the mechanistic explanations that are available for the deep-learning AI model include attention-head-level contribution values (e.g., attention-head-level contribution values produced by a direct attribution technique and/or an activation patching technique), then the computing platform 102 may (i) utilize such attention-head-level contribution values to rank the individual attention heads of the deep-learning AI model in order of how much they positively contribute to the deep-learning AI model's performance of the particular task (e.g., based on a single type of attention-head-level contribution values or perhaps multiple different types of attention-head-level contribution values that are combined together in some way), and then (ii) select a given number of the attention heads that are to have their parameters frozen by starting with the top-most attention head in the ranking (i.e., the attention head having the largest positive contribution) and then proceeding down the ranking of the attention heads until the given number of attention heads has been selected—where that given number corresponds to the target scope of the frozen-parameter space for this candidate quantized version of the deep-learning AI model. To illustrate with an example that is in the context of a GPT-2 small LLM, which is based on a decoder-only transformer architecture having 144 individual attention heads, the computing platform 102 may rank the 144 individual attention heads in order of how much they positively contribute to the deep-learning AI model's performance of the particular task and then select some number of sub-layers from the top of the ranking (e.g., the top 5, top 10, top 15, etc.).

As a fourth possible scenario, if the mechanistic explanations that are available for the deep-learning AI model include head-part-level contribution values (e.g., head-part-level contribution values produced by an activation patching technique), then the computing platform 102 may (i) utilize such head-part-level contribution values to rank the component parts of the attention heads within the deep-learning AI model in order of how much they positively contribute to the deep-learning AI model's performance of the particular task (e.g., based on a single type of head-part-level contribution values or perhaps multiple different types of head-part-level contribution values that are combined together in some way), and then (ii) select a given number of the component parts of the attention heads that are to have their parameters frozen by starting with the top-most component part in the ranking (i.e., the component part having the largest positive contribution) and then proceeding down the ranking of the component parts of the attention heads until the given number of component parts has been selected—where that given number corresponds to the target scope of the frozen-parameter space for this candidate quantized version of the deep-learning AI model. In this respect, the computing platform 102 may perform this ranking and selection collectively across multiple different types of component parts of the attention heads for which contribution values are available (e.g., across two or more of the key projectors, the query projectors, the value projectors, and/or attention-pattern generators of the attention heads), or may perform this ranking and selection separately for each different type of component part of the attention heads for which contribution values are available.

As a fifth possible scenario, if the mechanistic explanations that are available for the deep-learning AI model include computational-subgraph-level contribution values (e.g., computational-subgraph-level contribution values produced by a path patching technique), then the computing platform 102 may (i) utilize such computational-subgraph-level contribution values to rank the identified computational subgraphs of the deep-learning AI model (e.g., the circuits) in order of how much they positively contribute to the deep-learning AI model's performance of the particular task (e.g., based on a single type of computational-subgraph-level contribution values or perhaps multiple different types of computational-subgraph-level contribution values that are combined together in some way), and then (ii) select a given number of the computational subgraphs that are to have their parameters frozen by starting with the top-most computational subgraph in the ranking (i.e., the computational subgraph having the largest positive contribution) and then proceeding down the ranking of the computational subgraphs until the given number of them has been selected—where that given number corresponds to the target scope of the frozen-parameter space for this candidate quantized version of the deep-learning AI model. In this respect, the computing platform 102 may perform this ranking and selection collectively across all identified computational subgraphs, or may perform this ranking and selection separately for different subsets of the identified computational subgraphs (e.g., computational subgraphs comprised of different types of components and/or having differing levels of granularity).

In practice, the computing platform 102 could function to select internal aspects of the deep-learning AI model that are to have their associated parameters frozen from either a single level of granularity or multiple different levels of granularity of the deep-learning AI model, such as any combination of two or more of (i) layers, (ii) multi-head attention sub-layers, (iii) MLP layers, (iv) attention heads, (v) component parts of attention heads, and/or (vi) computational subgraphs, among other possibilities. In this respect, in implementations where the computing platform 102 is to select internal aspects of the deep-learning AI model that are to have their associated parameters frozen from multiple different levels of granularity, the computing platform 102 could select the internal aspects of the deep-learning AI model across the different levels of granularity in any of various manners.

For instance, in implementations where the target scope of the frozen-parameter space is defined in terms of counts of internal aspects of the deep-learning AI model at different levels of granularity, the computing platform 102 may carry out the foregoing functionality for each of the different levels of granularity in order to select respective sets of internal aspects of the deep-learning AI model at the different levels of granularity. To illustrate with one example, if the target scope of the frozen-parameter space is defined in terms of counts of MLP sub-layers and individual attention heads (and contribution values are available for both), the computing platform 102 could function to select a combination of (i) a first number of MLP sub-layers that are to have their associated parameters frozen and (ii) a second number of individual attention heads that are to have their associated parameters frozen—where the first and second numbers correspond to the target scope of the frozen-parameter space for this candidate quantized version of the deep-learning AI model. Or to illustrate with another example, if the target scope of the frozen-parameter space is defined in terms of counts of individual attention heads and computational subgraphs (and contributions are available for both), the computing platform 102 could function to select a combination of (i) a first number of individual attention heads that are to have their associated parameters frozen and (ii) a second number of computational subgraphs (i.e., combinations of multiple internal aspects of the model) that are to have their associated parameters frozen—where the first and second numbers correspond to the target scope of the frozen-parameter space for this candidate quantized version of the deep-learning AI model. Other examples are possible as well.

Alternatively, in implementations where the target scope of the frozen-parameter space is defined in terms of a percentage or count of parameters rather than counts of internal aspects of the deep-learning AI model, it is also possible that the computing platform 102 could (i) utilize the available contribution values to produce a single, combined ranking of the internal aspects of the deep-learning AI model across multiple different levels of granularity (e.g., a ranking that includes any two or more of layers, sub-layers, components such as attention heads, sub-components such as attention-head parts, and/or computational subgraphs such as circuits) and then (ii) select aspects from the ranking starting with the top-most internal aspect of the deep-learning AI model (i.e., the aspect having the largest positive contribution) and then proceeding down the ranking of the internal aspects of the deep-learning AI model until the number of parameters associated with the selected aspects reaches the target scope of the frozen-parameter space for this candidate quantized version of the deep-learning AI model.

The manner in which the computing platform 102 may select the internal aspects of the deep-learning AI model that are to have their associated parameters frozen across multiple different levels of granularity may take various other forms as well.

Further, as discussed above, the computing platform 102 may function to select the internal aspects of the deep-learning AI model that are to have their associated parameters frozen based on any of multiple different types of contribution values, such as any one or more of contribution values produced by a direct attribution technique, contribution values produced by an activation patching technique, and/or contribution values produced by a path patching technique, among other possibilities. In this respect, in implementations where the computing platform 102 has access to multiple different types of contribution values, the computing platform 102 could utilize the multiple types of contribution values to select the internal aspects of the deep-learning AI model that are to have their associated parameters frozen in various manners.

For instance, as one possible implementation, the computing platform 102 could identify different candidate sets of the internal aspects of the deep-learning AI model under evaluation based on the different types of contribution values—such as a first candidate set of internal aspects that are at the top of a first ranking that is based on a first type of contribution values and a second candidate set of internal aspects that are at the top of a second ranking that is based on a second type of contribution values—and then select the internal aspects of the deep-learning AI model that are to have their associated parameters frozen based on the different candidate that are identified by combining the candidate sets into a single, combined set of internal aspects and/or identifying any internal aspects of the deep-learning AI model that are included within multiple candidate sets of internal aspects.

As another possible implementation, the computing platform 102 could combine the different types of contribution values together into a single, combined set of contribution values for the internal aspects of the deep-learning AI model under evaluation—which may involve normalization in order to represent the different types of contribution values on a common scale and may result in multiple contribution values being listed for at least some of the internal aspects of the deep-learning AI model—and then select the internal aspects of the deep-learning AI model that are to have their associated parameters frozen based on that single, combined set of contribution values.

As yet another possible implementation, the computing platform 102 could combine the different types of contribution values together by producing aggregated contribution values for the internal aspects of the deep-learning AI model under evaluation on an internal aspect-by-aspect basis—such as by taking a respective weighted or unweighted average of the different types of contribution values for each internal aspect of the deep-learning AI model under evaluation and then select the internal aspects of the deep-learning AI model that are to have their associated parameters frozen based on the aggregated contributions that are produced for the internal aspects of the deep-learning AI model.

In each of the foregoing implementations, the internal aspects of the deep-learning AI model under evaluation could be at either the same level of granularity of multiple different levels of granularity, although it should be understood that the multiple different types of contribution values may not be available for internal aspects of the deep-learning AI model at certain levels of granularity (e.g., contribution values produced by a direct attribution technique may not be available for attention-head parts, contribution values produced by a direct attribution technique or an activation patching technique may not be available for computational subgraphs, etc.).

The manner in which the computing platform 102 may select the internal aspects of the deep-learning AI model that are to have their associated parameters frozen based on multiple different types of contribution values may take various other forms as well.

The function of utilizing the mechanistic explanations for the deep-learning AI model to select which internal aspects of the deep-learning AI model are to have their associated parameters frozen may take various other forms as well, including but not limited to the possibility that the internal aspects of the deep-learning AI model could take forms other than those discussed above.

After utilizing the mechanistic explanations for the deep-learning AI model to select which internal aspects of the deep-learning AI model are to have their associated parameters frozen, the computing platform 102 may next identify, for each selected aspect of the deep-learning AI model, an associated group of parameters that are to be frozen.

For example, for any layer of the deep-learning AI model that is selected, the computing platform 102 may identify an associated group of parameters for the layer, which may comprise the numerical values within the learnable matrices of the muti-head attention sub-layer and the MLP sub-layer of the layer (e.g., the Query, Key, and Value weight matrices of each individual attention head, the output projection matrix of the multi-head attention sub-layer, and the linear-layer weight matrices of the MLP sub-layer) and perhaps also the corresponding bias terms, among other possible types of parameters that may be associated with a layer.

As another example, for any muti-head attention sub-layer of the deep-learning AI model that is selected, the computing platform 102 may identify an associated group of parameters for the muti-head attention sub-layer, which may comprise the numerical values within the learnable matrices of the muti-head attention sub-layer (e.g., the Query, Key, and Value weight matrices of each individual attention head and the output projection matrix of the multi-head attention sub-layer) and perhaps also the corresponding bias terms, among other possible types of parameters that may be associated with a muti-head attention sub-layer.

As yet another example, for any MLP sub-layer of the deep-learning AI model that is selected, the computing platform 102 may identify an associated group of parameters for the MLP sub-layer, which may comprise the numerical values within the learnable matrices of the MLP sub-layer of the layer (e.g., the linear-layer weight matrices of the MLP sub-layer) and perhaps also the corresponding bias terms, among other possible types of parameters that may be associated with an MLP sub-layer.

As still another example, for any individual attention head of the deep-learning AI model that is selected, the computing platform 102 may identify an associated group of parameters for the attention head, which may comprise the numerical values within the learnable matrices of the attention head (e.g., the Query, Key, and Value weight matrices of the attention head) and perhaps also the corresponding bias terms, among other possible types of parameters that may be associated with an individual attention head.

As a further example, for any individual component part of an attention head of the deep-learning AI model that is selected, the computing platform 102 may identify an associated group of parameters for the component part of the attention head, which may comprise the numerical values within a learnable matrix of the component part (e.g., a given one of the Query, Key, or Value weight matrices of the attention head) and perhaps also the corresponding bias term, among other possible types of parameters that may be associated with an individual component part of an attention head.

As still a further example, for any computational subgraph of the deep-learning AI model that is selected, the computing platform 102 may identify an associated group of parameters for the computational subgraph, which may comprise the parameters associated with the particular combination of model components that make up the computational subgraph.

The function of identifying an associated group of parameters for an internal aspect of the deep-learning AI model that is selected to have its parameters frozen may take other forms as well.

Lastly, after identifying the associated groups of parameters for the internal aspects of the deep-learning AI model that are selected to have their parameters frozen, the computing platform 102 may compile the associated groups of parameters together into a collective set of parameters, which may then be identified as the frozen-parameter space for the candidate quantized version of the deep-learning AI model.

The functionality for utilizing the mechanistic explanations for the deep-learning AI model as a basis for identifying the frozen-parameter space having the target scope for this candidate quantized version of the deep-learning AI model may take other forms as well.

At block 802C, after identifying the frozen-parameter space for the candidate quantized version of the deep-learning AI model, the computing platform 102 may next identify an unfrozen-parameter space for the candidate quantized version of the deep-learning AI model, which may comprise whichever of the deep-learning AI model's numerical parameters are not included in the frozen-parameter space that is identified for this candidate quantized version of the deep-learning AI model. In other words, the computing platform 102 may identify the unfrozen-parameter space to be the complement of the frozen-parameter space with respect to the full parameter space of the deep-learning AI model.

However, the unfrozen-parameter space that is identified for the candidate quantized version of the deep-learning AI model could take other forms as well, including but not limited to the possibility that, in addition to the frozen-parameter space that is identified based on the mechanistic explanations, there are other parameters of the deep-learning AI model that are to have their precision frozen during quantization and may thus be excluded from the unfrozen-parameter space. For instance, the deep-learning AI model may include certain parameters that are not to have their precision reduced regardless of the scenario, such as parameters associated with certain internal aspects of the deep-learning AI model that are included on a “whitelist” or the like (e.g., parameters associated with layer normalization steps, the final output layer, input embeddings, etc.), in which case these parameters may additionally be excluded from the unfrozen-parameter space.

At block 802D, the computing platform 102 may produce the candidate quantized version of the deep-learning AI model by applying the target quantization strategy that is initialized for this candidate quantized version of the deep-learning AI model in order to reduce the precision of the numerical parameters in the unfrozen-parameter space identified for this candidate quantized version of the deep-learning AI model from their full precision level to the reduced precision level.

For instance, the computing platform 102 may apply the target quantization strategy to the numerical parameters in each learnable matrix and corresponding bias term that was not identified inclusion in the frozen-parameter space—such as learnable matrices and corresponding bias terms of unselected multi-head attention sub-layers and MLP sub-layers—in order to reduce the precision of such numerical parameters from their full precision level to the reduced precision level (which as noted above could comprise FP16, int8, or int 4, among other possibilities.

Further, at a high level, the function of reducing the precision of the numerical parameters in the unfrozen-parameter space identified for this candidate quantized version of the deep-learning AI model from their full precision level to the reduced precision level may generally involve (i) copying the unfrozen parameters, (ii) converting the unfrozen parameters to the reduced precision level (which could involve operations such as scaling, calibration, and/or zero-point calculation that are either performed prior to the conversion or performed during the course of the conversion process), and then (iii) storing the converted values in data storage. In this respect, the target quantization strategy may employ any suitable quantization technique now known or later developed for converting the unfrozen parameters to the reduced precision level, including but not limited to static quantization techniques and/or dynamic quantization techniques. Further, in line with the discussion above, it is possible that the target quantization strategies that are initialized for different iterations of the quantization functionality could employ different types of quantization techniques.

The function of applying the target quantization strategy that is initialized for this candidate quantized version of the deep-learning AI model in order to reduce the precision of the numerical parameters in the unfrozen-parameter space from their full precision level to the reduced precision level may take other forms as well.

At block 802E, the computing platform 102 may evaluate whether the candidate quantized version of the deep-learning AI model satisfies acceptability criteria that has been defined for the quantized version of the deep-learning AI model. Such acceptability criteria could take any of various forms.

For instance, as one possibility, the acceptability criteria may include at least one condition related to the predictive accuracy of the quantized version of the deep-learning AI model, such as a condition requiring a given type of metric for quantifying the predictive accuracy of the quantized version of the deep-learning AI model to be greater than (or at least equal to) a defined threshold. In this respect, the given type of metric for quantifying the predictive accuracy of the deep-learning AI model may include an accuracy metric that indicates what percentage of the model's predictions are considered to be correct, an exact match (EM) metric that indicates what percentage of the model's predictions match exactly with a ground-truth value, a precision metric that indicates how many of the model's predictions are correct, a recall metric that indicates how many of the correct responses were predicted by the model, and/or an F1 metric that represents a harmonic mean of the precision and recall metrics, among other possible types of metrics for quantifying the predictive accuracy of the quantized version of deep-learning AI model. In turn, the defined threshold may comprise a value represented in terms of the given type of metric (e.g., a percentage value for an accuracy or EM metric, a count value for a precision or recall metric, etc.) that serves as a defined cutoff for determining whether the predictive accuracy of the quantized version of the deep-learning AI model is acceptable.

In such an implementation where the acceptability criteria includes at least one condition related to the predictive accuracy of the quantized version of the deep-learning AI model, the computing platform 102 may evaluate whether the candidate quantized version of the deep-learning AI model satisfies that condition by (i) running the candidate quantized version of the deep-learning AI model using test records that each includes a respective model input and a corresponding ground-truth value for the model output, (ii) comparing the predictions output by the candidate quantized version of the deep-learning AI model for the test records to the corresponding ground-truth values, (iii) based on the comparison, computing a value for a given type of metric that quantifies the predictive accuracy of the quantized version of the deep-learning AI model, and (iv) determining whether the computed value for the given type of metric is greater than (or at least equal to) a defined threshold for predictive accuracy.

As another possibility, the acceptability criteria may include at least one condition related to the prediction time of the quantized version of the deep-learning AI model, such as a condition requiring a given type of metric for quantifying the prediction time of the quantized version of the deep-learning AI model to be less than (or at least equal to) a defined threshold. In this respect, the given type of metric for quantifying the prediction time of the deep-learning AI model may include a metric that indicates prediction time on a per-token basis (e.g., number of milliseconds per token) or a metric that indicates prediction time on a per-response basis (e.g., duration of time to respond to a prompt), among other possible types of metrics for quantifying the predictive time of the quantized version of deep-learning AI model. In turn, the defined threshold may comprise a value represented in terms of the given type of metric (e.g., a duration of time per token or per response) that serves as a defined cutoff for determining whether the predictive time of the quantized version of the deep-learning AI model is acceptable.

In such an implementation where the acceptability criteria includes at least one condition related to the prediction time of the quantized version of the deep-learning AI model, the computing platform 102 may evaluate whether the candidate quantized version of the deep-learning AI model satisfies that condition by (i) running the candidate quantized version of the deep-learning AI model using test records that each includes a respective model input, (ii) for each run, measuring a value for a given type of metric that quantifies the predictive time of the quantized version of the deep-learning AI model, (iii) aggregating the measured values for the given type of metric across the runs (e.g., by taking an average of the measured values), and (iv) determining whether the aggregated value for the given type of metric is less than (or at least equal to) a defined threshold for prediction time.

As another possibility, the acceptability criteria may include at least one condition related to the size of the quantized version of the deep-learning AI model, such as a condition requiring a given type of metric for quantifying the size of the quantized version of the deep-learning AI model to be less than (or at least equal to) a defined threshold. In this respect, the given type of metric for quantifying the size of the deep-learning AI model may include a metric that indicates a model's on-disk storage footprint or a model's memory footprint, among other possible types of metrics for quantifying the size of the quantized version of deep-learning AI model. In turn, the defined threshold may comprise a value represented in terms of the given type of metric that serves as a defined cutoff for determining whether the size of the quantized version of the deep-learning AI model is acceptable (e.g., an on-disk storage footprint threshold, a memory footprint threshold, etc.).

In an implementation where the acceptability criteria includes a condition related to on-disk storage footprint, the computing platform 102 may evaluate whether the candidate quantized version of the deep-learning AI model satisfies that condition by (i) determining the file size of the candidate quantized version of the deep-learning AI model after it has been saved to disk, and (ii) determining whether the file size is less than (or at least equal to) a defined threshold for on-disk storage size. On the other hand, in an implementation where the acceptability criteria includes a condition related to memory footprint, the computing platform 102 may evaluate whether the candidate quantized version of the deep-learning AI model satisfies that condition by (i) running the candidate quantized version of the deep-learning AI model using test records that each includes a respective model input, (ii) for each run, measuring an amount of memory (e.g., RAM or VRAM) consumed by the candidate quantized version of the deep-learning AI model, (iii) aggregating the measured amount of memory consumed across the runs (e.g., by taking an average of the measured values), and (iv) determining whether the aggregated value is less than (or at least equal to) a defined threshold for memory footprint.

The acceptability criteria that is defined for the quantized version of the deep-learning AI model may comprise conditions that are based on various other types of metrics for quantifying the performance of a deep-learning AI model as well, examples of which may include an ELO score, a perplexity score, a massive multitask language understanding (MMLU) score, a HumanEval score, and/or a human-assigned score related to faithfulness, completeness, or minimality, among other possible types of metrics for quantifying the performance of a deep-learning AI model.

Further, in practice, the acceptability criteria that has been defined for the quantized version of the deep-learning AI model may comprise either a single one of the foregoing types of conditions or a combination of multiple of the foregoing types of conditions (e.g., conditions related to two or more predictive accuracy, prediction time, on-disk storage footprint, memory footprint, etc.).

The function of evaluating whether the candidate quantized version of the deep-learning AI model satisfies the acceptability criteria may take various other forms as well, including but not limited to the possibility that the computing platform 102 may (i) utilize a scoring function to combine multiple performance-metric values for the candidate quantized version of the deep-learning AI model into a score value, and then (ii) compare the score value of the candidate quantized version of the deep-learning AI model to a score threshold that serves as a defined cutoff for determining whether the candidate quantized version of the deep-learning AI model. is acceptable.

If the computing platform 102 determines at block 802E that the candidate quantized version of the deep-learning AI model does satisfy the acceptability criteria, then the computing platform 102 may include the candidate quantized version of the deep-learning AI model in the group of candidate quantized versions of the deep-learning AI model that are to be further evaluated for possible deployment. Additionally, in an implementation where a sequential, stateful iterative approach is being employed for producing the candidate quantized versions of the deep-learning AI model, the determination that this candidate quantized version of the deep-learning AI model satisfies the acceptability criteria may serve as a trigger for the computing platform 102 to proceed to a next iteration of the functionality of FIG. 8B and thereby produce a next candidate quantized version of the deep-learning AI model.

On the other hand, if the computing platform 102 determines at block 802E that the candidate quantized version of the deep-learning AI model fails to satisfy the acceptability criteria, then the computing platform 102 may discard the candidate quantized version of the deep-learning AI model. Additionally, in an implementation where a sequential, stateful iterative approach is being employed for producing the candidate quantized versions of the deep-learning AI model, the determination that this candidate quantized version of the deep-learning AI model fails to satisfy the acceptability criteria may serve as a stopping condition for the iterations that triggers the computing platform 102 to stop the process of producing the candidate quantized versions of the deep-learning AI model—or at least stop producing the candidate quantized versions of the deep-learning AI model within the current sub-loop of the iterations and proceed to a next sub-loop of the iterations (e.g., by updating the quantization dimension that is controlled by the outer loop).

The functionality for producing a particular candidate quantized version of the deep-learning AI model may take other forms as well.

Returning to FIG. 8A, while producing the multiple candidate quantized versions of the deep-learning AI model at block 802, it is also possible that the computing platform 102 could decide to initiate a follow-up mechanistic interpretability investigation for the deep-learning AI model's performance of the particular task in order to produce new mechanistic explanations that are of a different type and/or at a different level of granularity. For instance, if the computing platform 102 is unable to produce a sufficient number of candidate quantized versions of the deep-learning AI model that meet the acceptability criteria based on the mechanistic explanations that are currently available for the deep-learning AI model's performance of the particular task, then the computing platform 102 may initiate a follow-up mechanistic interpretability investigation for the deep-learning AI model's performance of the particular task in order to produce new mechanistic explanations that are of a different type and/or at a different level of granularity, and may then carry out additional iterations of the functionality of FIG. 8B utilizing the new mechanistic explanations so as to produce additional candidate quantized versions of the deep-learning AI model. In this respect, the follow-up mechanistic interpretability investigation could involve functionality for producing a different type of mechanistic explanations (e.g., by using a different mechanistic technique such as activation patching and/or path patching instead of direct attribution) and/or could involve functionality for producing mechanistic explanations at a more granular level (e.g., at an attention-head-level or perhaps a head-part-level), among other possibilities.

Alternatively, instead of first initiating the functionality for producing the multiple candidate quantized versions of the deep-learning AI model based on the mechanistic explanations that are currently available for the deep-learning AI model's performance of the particular task and then initiating a follow-up mechanistic interpretability investigation thereafter if needed, it is possible that the computing platform 102 could be configured to expand the scope of the mechanistic interpretability investigation that is initially conducted (e.g., the mechanistic interpretability investigation discussed above with reference to FIG. 3) to include functionality for producing other types of mechanistic explanations and/or functionality for producing mechanistic explanations at other levels of granularity. However, expanding the scope of the initial mechanistic interpretability investigation will also increase the time and resources required to conduct that initial mechanistic interpretability investigation, which needs to be balanced against the potential benefits of doing so.

The function of utilizing the mechanistic explanations for the deep-learning AI model's performance of the particular task as a basis for producing the multiple candidate quantized versions of the deep-learning AI model may take various other forms as well.

Turning next to block 804, after producing the multiple candidate quantized versions of the deep-learning AI model, the computing platform 102 may select a given one of the multiple candidate quantized versions of the deep-learning AI model as a final quantized version of the deep-learning AI model that is to be deployed in place of the original version of the deep-learning AI model. This functionality for selecting the final quantized version of the deep-learning AI model may take any of various forms.

As one possibility, the functionality for selecting the final quantized version of the deep-learning AI model may begin with the computing platform 102 determining, for each candidate quantized version of the deep-learning AI model that was produced at block 802 (i.e., the candidate quantized versions that satisfy the acceptability criteria), a respective set of values for certain metrics that quantify the performance of the candidate quantized version of the deep-learning AI model. Such metrics that quantify the performance of the candidate quantized versions of the deep-learning AI model could take any of various forms, and in at least some implementations, could comprise any one or more of the types of metrics described above with reference to the acceptability criteria (e.g., related to one or more of predictive accuracy, prediction time, on-disk storage footprint, memory footprint, ELO score, perplexity score, MMLU score, HumanEval score, etc.). In this respect, the functionality for determining the respective set of values for such metrics may be similar to the functionality described above with reference to the acceptability criteria. However, the metrics that quantify the performance of the candidate quantized versions of the deep-learning AI model, and the functionality for determining the values of such metrics, may take various other forms as well.

After determining the respective sets of performance-metric values for the candidate quantized versions of the deep-learning AI model, the computing platform 102 may next apply certain selection logic to the respective sets of performance-metric values in order to select, from the candidate quantized versions of the deep-learning AI model, the final quantized version of the deep-learning AI model. The selection logic that is utilized to select the final quantized version of the deep-learning AI model may take any of various forms.

To illustrate with one example scenario where there are two metrics being utilized to quantify performance of the candidate quantized versions of the deep-learning AI model (e.g., metrics related to predictive accuracy and memory footprint), the selection logic may encode a threshold for a first one of the two metrics and then define a selection process whereby the computing platform 102 limits its analysis to candidate quantized versions of the deep-learning AI model that do not violate the threshold for the first metric and selects whichever of those candidate quantized versions of the deep-learning AI model has the best value for the second of the two metrics. For example, the selection logic may encode a threshold for predictive accuracy and then define a selection process whereby the computing platform 102 limits its analysis to candidate quantized versions of the deep-learning AI model having a predictive accuracy that exceeds (or at least meets) the threshold for predictive accuracy and selects whichever of those candidate quantized versions of the deep-learning AI model has the smallest memory footprint. Or conversely, the selection logic may encode a threshold for memory footprint and then define a selection process whereby the computing platform 102 limits its analysis to candidate quantized versions of the deep-learning AI model having a memory footprint that is less than (or at least equal to) the threshold for memory footprint and selects whichever of those candidate quantized versions of the deep-learning AI model has the best predictive accuracy. Many other examples are possible as well.

The selection logic that is utilized by the computing platform 102 to select the final quantized version of the deep-learning AI model may take various other forms as well, including but not limited to the possibility that the selection logic may (i) utilize a scoring function to combine each candidate quantized version's respective set of performance-metric values into a respective score value, and then (ii) compare the respective score values of the candidate quantized versions of the deep-learning AI model and thereby determine which of the candidate quantized versions has a highest score value, which is then designated as the final quantized version of the deep-learning AI model.

The functionality for selecting the final quantized version of the deep-learning AI model may take other forms as well.

After the final quantized version of the deep-learning AI model is selected, the computing platform 102 may also optionally update the final quantized version of the deep-learning AI model so as to further improve the performance of the deep-learning AI model. This optional function of updating the final quantized version of the deep-learning AI model may take any of various forms, examples of which may include fine tuning, LoRA adaptation, pruning, knowledge distillation, alignment with reinforcement learning techniques, and/or optimization for performance (e.g., modifications such that inference on specific hardware is faster), among other possible ways in which the the final quantized version of the deep-learning AI model could be updated. As one specific example to illustrate, the computing platform 102 could optionally fine-tune the final quantized version of the deep-learning AI model using a task-specific training dataset so as to further improve the predictive accuracy of the deep-learning AI model when it performs the selected task.

The optional function of updating the final quantized version of the deep-learning AI model could take other forms as well.

At block 806, after the final quantized version of the deep-learning AI model is selected (and optionally updated), the computing platform 102 may then cause the final quantized version of the deep-learning AI model to be deployed for execution on a given computing platform, which could either be the computing platform 102 itself or some other computing platform (e.g., a different computing platform, an edge computing platform, etc.).

In a scenario where the final quantized version of the deep-learning AI model is to be executed at the computing platform 102, the function of deploying the final quantized version of the deep-learning AI model may involve loading the final quantized version of the deep-learning AI model into an execution environment and then beginning to use the final quantized version of the deep-learning AI model to produce model outputs (e.g., predicted responses to questions related to the selected task) based on model inputs that are received in the form of model prompts or the like.

On the other hand, in a scenario where the final quantized version of the deep-learning AI model is to be executed at some other computing platform, such as a different computing platform or an edge computing platform, the function of deploying the final quantized version of the deep-learning AI model may involve sending a representation of the final quantized version of the deep-learning AI model to that other computing platform via a network-based communication path, after which time the other computing platform may load the final quantized version of the deep-learning AI model into an into an execution environment and begin using the final quantized version of the deep-learning AI model to produce model outputs (e.g., predicted responses to questions related to the selected task) based on model inputs that are received in the form of model prompts or the like.

The function of deploying the final quantized version of the deep-learning AI model may take other forms as well.

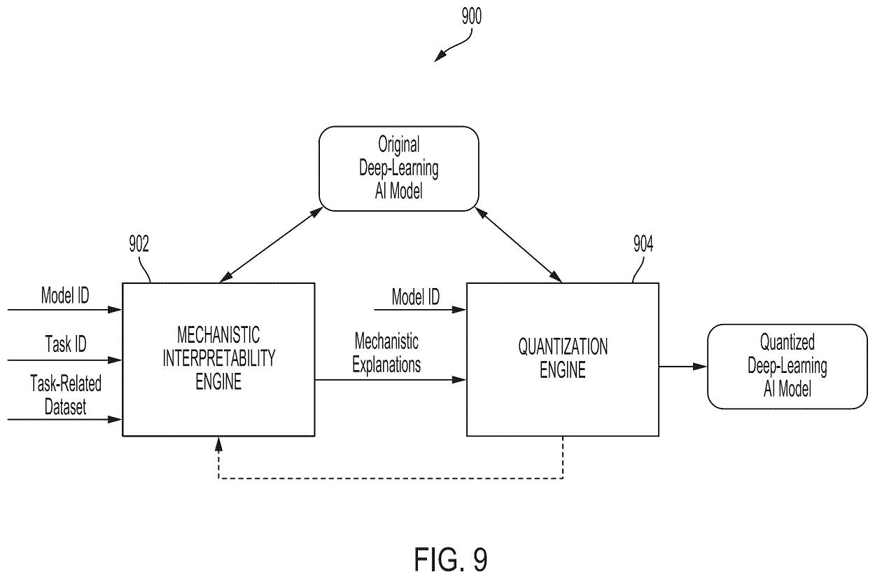

Turning next to FIG. 9, one possible example of a software-based pipeline 900 that may be designed and implemented in accordance with the present disclosure is illustrated. In practice, the example software-based pipeline 900 could be installed on and executed by any one or more computing platforms that are capable of performing the example operations of the example software-based pipeline 900 (e.g., computing platform 102 of FIG. 1), and in some cases, different components of the example software-based pipeline 900 may be executed by different computing platforms that communicate with one another via a network-based communication path. Further, it should be understood that the example software-based pipeline 900 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown in FIG. 9, the example software-based pipeline 900 includes a mechanistic interpretability engine 902. The mechanistic interpretability engine 902 is operable to receive inputs that include (i) an indication of a particular deep-learning AI model that is to be utilized to perform a particular task (and is capable of being interpreted by the mechanistic interpretability engine 902), (ii) an indication of the particular task that is to be performed using the particular deep-learning AI model (e.g., a particular task within the financial services industry), and/or (iii) a dataset corresponding to the particular task that comprises a defined set of input questions for use in evaluating the deep-learning AI model's behavior while it is performing the particular task, among other possible inputs of the mechanistic interpretability engine 902.

Based on these inputs, the mechanistic interpretability engine 902 may function to (i) conduct a mechanistic interpretability investigation based on runs of the deep-learning AI model that are carried out using the defined set of input questions for the particular task and thereby (ii) produce and output mechanistic explanations the deep-learning AI model's behavior while it is performing the particular task.

As shown in FIG. 9, the example software-based pipeline 900 additionally includes a quantization engine 904. The quantization engine 904 is operable to receive (i) an indication of the particular deep-learning AI model and (ii) the mechanistic explanations that are produced and output by the mechanistic interpretability engine 902 for the particular deep-learning AI model, among other possible inputs of the quantization engine 904 (e.g., possible values for the quantization dimensions, to the extent that such values are not hardcoded into the quantization engine 904).

Based on these inputs, the quantization engine 904 may function to (i) produce multiple candidate quantized versions of the particular deep-learning AI model, (ii) evaluate the multiple candidate quantized versions of the particular deep-learning AI model (e.g., based on certain metrics the quantify the performance of the candidate quantized versions), and (iii) based on the evaluation, select and output a given one of the candidate quantized versions of the particular deep-learning AI model as a final quantized version of the particular deep-learning AI model that is to be deployed for execution in place of the particular deep-learning AI model.

As further shown in FIG. 9, the example software-based pipeline 900 may optionally include a feedback loop from the quantization engine 904 back to the mechanistic interpretability engine 902. For instance, in a scenario where the quantization engine 904 is unable to produce a sufficient number of candidate quantized versions of the deep-learning AI model that are acceptable based on the initial mechanistic explanations that are output by the mechanistic interpretability engine 902, then the quantization engine 904 may initiate a follow-up mechanistic interpretability investigation for the deep-learning AI model's performance of the particular task in order to produce new mechanistic explanations that are of a different type and/or at a different level of granularity, and may then produce additional candidate quantized versions of the deep-learning AI model based on the new mechanistic explanations before selecting the final quantized version of the deep-learning AI model.

A software-based pipeline that is designed and implemented in accordance with the present disclosure could take various other forms as well.

Certain variations and/or extensions of the disclosed functionality that is described above with reference to FIGS. 3-9 may also be possible.

For instance, while the disclosed technology is at times described above in the context of a deep-learning AI model that is to be utilized by an organization to perform a particular task related to the organization's business (e.g., to help flag problems, generate insights, or make decisions related to the organization's business), which may sometimes be referred to as an “internal-use” deep-learning AI model, it is possible that the disclosed functionality may be utilized in connection with a “consumer-facing” deep-learning AI model that is to be utilized to perform tasks related to end users rather than a business organization (or perhaps some other type of deep-learning AI model that does not qualify as either an internal-use or consumer-facing deep-learning AI model). To illustrate with an example, a provider of a consumer-facing LLM (e.g., OpenAI, Google, Microsoft, Meta, etc.) could utilize the disclosed technology to (i) produce mechanistic explanations for the consumer-facing LLM's behavior when performing a particular task that is of interest to the provider (e.g., a particular type of question-answering or classification task) and then (ii) utilize the mechanistic explanations as a basis for better understanding and/or improving the consumer-facing LLM, which could involve the disclosed functionality for utilizing the mechanistic explanations to perform quantization of the consumer-facing LLM.

As another possibility, while the disclosed technology is at times described above in the context of a particular task within the financial services industry, it is possible that the disclosed functionality may be utilized in connection with another type of well-defined task that is to be performed using a deep-learning AI model.

As yet another possibility, while the disclosed technology is at times described above in the context of a deep-learning type of AI model, it is possible that the disclosed functionality may be utilized in connection with another type of AI model that does not qualify as a deep-learning AI model but may nevertheless be capable of being interpreted via mechanistic interpretability techniques.

As still another possibility, while the disclosed quantization functionality is at times described above with reference to intelligently quantizing a deep-learning AI model based on mechanistic explanations that are produced by the functionality of the disclosed framework that is described with reference to FIG. 3, it is possible that the disclosed quantization functionality may intelligently quantize a deep-learning AI model based on mechanistic explanations for the deep-learning AI model that are obtained in some other way and/or take some other form.

As a further possibility, while the iterations of the quantization functionality are described above in terms of two possible quantization dimensions, which are the scope of the frozen-parameter space and the quantization strategy for reducing the precision of the unfrozen-parameter space, it is possible that the iterations of the quantization functionality could be defined in terms of other types of quantization dimensions in addition or alternative to the scope of the frozen-parameter space and the quantization strategy for reducing the precision of the unfrozen-parameter space.

As yet a further possibility, while the iterations of the quantization functionality are described above in terms of utilizing the mechanistic explanations for the deep-learning AI model as a basis for dividing the parameters of the deep-learning AI model into a frozen-parameter space and a single unfrozen-parameter space and then using a single target quantization strategy to reduce the precision of all of the parameters in the unfrozen-parameter space, it is possible that at least some iterations of the quantization functionality could involve (i) utilizing the mechanistic explanations for the deep-learning AI model as a basis for dividing the parameters of the deep-learning AI model into a frozen-parameter space and a set of multiple different unfrozen-parameter spaces and then (ii) using different target quantization strategies to reduce the precision of the parameters in the multiple different unfrozen-parameter spaces—such as quantization strategies that reduce the precision of the parameters to different reduced precision levels and/or employe different quantization techniques.

To illustrate with an example, a given iteration of the quantization functionality may involve (i) utilizing the mechanistic explanations for the deep-learning AI model as a basis for dividing the parameters of the deep-learning AI model into a frozen-parameter space comprising parameters for internal aspects of the deep-learning AI model that have the highest contribution values, a first unfrozen-parameter space comprising parameters for internal aspects of the deep-learning AI model that have intermediate contribution values, and a second unfrozen-parameter space comprising parameters for internal aspects of the deep-learning AI model that have lowest contribution values, (ii) utilizing a first quantization strategy to reduce the first unfrozen-parameter space to a first reduced precision level (e.g., FY16), and (iii) utilizing a second quantization strategy to reduce the second unfrozen-parameter space to a second reduced precision level that is lower than the first reduced precision level (e.g., int16). Other examples are possible as well.

Other variations and/or extensions of the disclosed functionality that is described above with reference to FIGS. 3-9 may be possible as well.

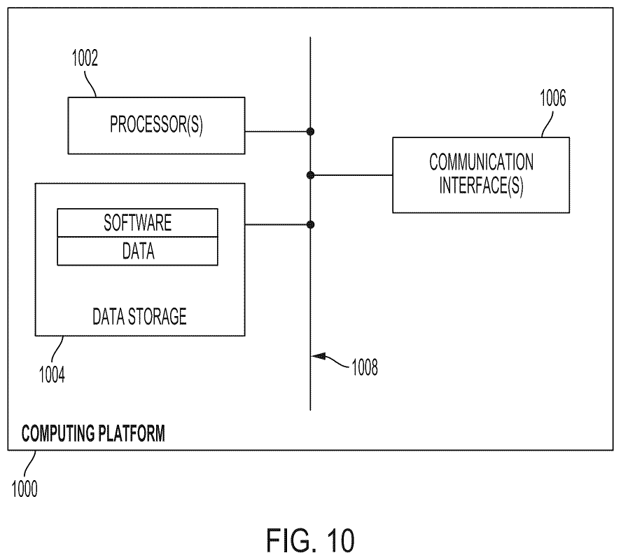

Turning now to FIG. 10, a simplified block diagram is provided to illustrate some structural components that may be included in an example computing platform 1000 that may be configured perform some or all of the functions discussed herein for creating a data science model in accordance with the present disclosure. At a high level, computing platform 1000 may generally comprise any one or more computer systems (e.g., one or more servers) that collectively include one or more processors 1002, data storage 1004, and one or more communication interfaces 1006, all of which may be communicatively linked by a communication link 1008 that may take the form of a system bus, a communication network such as a public, private, or hybrid cloud, or some other connection mechanism. Each of these components may take various forms.

For instance, the one or more processors 1002 may comprise one or more processor components, such as one or more central processing units (CPUs), graphics processing unit (GPUs), application-specific integrated circuits (ASICs), digital signal processor (DSPs), and/or a programmable logic devices such as a field programmable gate arrays (FPGAs), among other possible types of processing components. In line with the discussion above, it should also be understood that the one or more processors 1002 could comprise processing components that are distributed across a plurality of physical computing devices connected via a network, such as a computing cluster of a public, private, or hybrid cloud.

In turn, data storage 1004 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 1004 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 10, data storage 1004 may be capable of storing both (i) program instructions that are executable by processor 1002 such that the computing platform 1000 is configured to perform any of the various functions disclosed herein, and (ii) data that may be received, derived, or otherwise stored by computing platform 1000.

The one or more communication interfaces 1006 may comprise one or more interfaces that facilitate communication between computing platform 1000 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 1000 may additionally include or have an interface for connecting to one or more user-interface components that facilitate user interaction with the computing platform 1000, such as a keyboard, a mouse, a trackpad, a display screen, a touch-sensitive interface, a stylus, a virtual-reality headset, and/or one or more speaker components, among other possibilities.

It should be understood that computing platform 1000 is one example of a computing platform that may be used with the embodiments described herein. Numerous other arrangements are possible and contemplated herein. For instance, other computing systems may include additional components not pictured and/or more or less of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one processor;
at least one non-transitory computer-readable medium; and
program instructions stored on the at least one non-transitory computer-readable medium that, when executed by the at least one processor, cause the computing platform to:
obtain a dataset that comprises at least one defined set of input questions for use in conducting a mechanistic interpretability investigation of a given deep-learning artificial intelligence (AI) model's performance of a given task;
utilize the at least one defined set of input questions to carry out runs of the given deep-learning AI model;
based on the runs of the given deep-learning AI model, conduct the mechanistic interpretability investigation of the given deep-learning AI model and thereby produce mechanistic explanations for the given deep-learning AI model's performance of the given task;
utilize the mechanistic explanations for the given deep-learning AI model's performance of the given task as a basis for quantizing the given deep-learning AI model.

2. The computing platform of claim 1, wherein the given task comprises a task within the financial services industry.

3. The computing platform of claim 2, wherein the given task comprises one of (i) determining whether the organization's communications with consumers are governed by the Telephone Consumer Protection Act (TCPA), (ii) determining whether the organization's interactions with consumers that should be flagged for further review as a possible violation of Unfair or Deceptive Acts or Practices (UDAAP), or (iii) determining whether the organization's interactions with consumers violate fair lending regulations.

4. The computing platform of claim 1, wherein the at least one defined set of input questions comprises a clean set of input questions.

5. The computing platform of claim 4, wherein the at least one defined set of input questions comprises a corrupted set of input questions corresponding to the clean set of input questions.

6. The computing platform of claim 1, wherein the at least one defined set of input questions are produced based on one or more input templates that are tailored to the given task.

7. The computing platform of claim 1, wherein the mechanistic interpretability investigation of the given deep-learning AI model involves one or more of (i) a direct attribution technique, (ii) an activation patching technique, or (iii) a path patching technique.

8. The computing platform of claim 1, wherein the program instructions that, when executed by the at least one processor, cause the computing platform to utilize the mechanistic explanations for the given deep-learning AI model's performance of the given task as a basis for quantizing the given deep-learning AI model comprise program instructions that, when executed by the at least one processor, cause the computing platform to:
utilize the mechanistic explanations for the given deep-learning AI model's performance of the given task as a basis for producing multiple quantized versions of the given deep-learning AI model that differ from one another with respect to one or both of (a) which subset of the given deep-learning AI model's parameters had their precision frozen during quantization and (b) which quantization strategy was utilized to reduce a precision of the given deep-learning AI model's parameters that did not have their precision frozen during quantization; and
select a given one of the multiple quantized versions of the given deep-learning AI model as a final quantized version of the given deep-learning AI model.

9. The computing platform of claim 8, wherein, for each of the multiple quantized versions of the given deep-learning AI model, the subset of parameters that had their precision frozen during quantization was determined based on the mechanistic explanations for the given deep-learning AI model's performance of the given task.

10. The computing platform of claim 9, wherein, for each of the multiple quantized versions of the given deep-learning AI model, the subset of parameters that had their precision frozen during quantization comprises parameters associated with a respective subset of the given deep-learning AI model's internal aspects that is selected based on the mechanistic explanations for the given deep-learning AI model's performance of the given task.

11. A non-transitory computer-readable medium, wherein the non-transitory computer-readable medium is provisioned with program instructions that, when executed by at least one processor, cause a computing platform to:
obtain a dataset that comprises at least one defined set of input questions for use in conducting a mechanistic interpretability investigation of a given deep-learning artificial intelligence (AI) model's performance of a given task;
utilize the at least one defined set of input questions to carry out runs of the given deep-learning AI model;
based on the runs of the given deep-learning AI model, conduct the mechanistic interpretability investigation of the given deep-learning AI model and thereby produce mechanistic explanations for the given deep-learning AI model's performance of the given task;
utilize the mechanistic explanations for the given deep-learning AI model's performance of the given task as a basis for quantizing the given deep-learning AI model.

12. The non-transitory computer-readable medium of claim 11, wherein the program instructions that, when executed by the at least one processor, cause the computing platform to utilize the mechanistic explanations for the given deep-learning AI model's performance of the given task as a basis for quantizing the given deep-learning AI model comprise program instructions that, when executed by the at least one processor, cause the computing platform to:
utilize the mechanistic explanations for the given deep-learning AI model's performance of the given task as a basis for producing multiple quantized versions of the given deep-learning AI model that differ from one another with respect to one or both of (a) which subset of the given deep-learning AI model's parameters had their precision frozen during quantization and (b) which quantization strategy was utilized to reduce a precision of the given deep-learning AI model's parameters that did not have their precision frozen during quantization; and
select a given one of the multiple quantized versions of the given deep-learning AI model as a final quantized version of the given deep-learning AI model.

13. A method carried out by a computing platform, the method comprising:
obtaining a dataset that comprises at least one defined set of input questions for use in conducting a mechanistic interpretability investigation of a given deep-learning artificial intelligence (AI) model's performance of a given task;
utilizing the at least one defined set of input questions to carry out runs of the given deep-learning AI model;
based on the runs of the given deep-learning AI model, conducting the mechanistic interpretability investigation of the given deep-learning AI model and thereby producing mechanistic explanations for the given deep-learning AI model's performance of the given task;
utilizing the mechanistic explanations for the given deep-learning AI model's performance of the given task as a basis for quantizing the given deep-learning AI model.

14. The method of claim 13, wherein the given task comprises a task within the financial services industry.

15. The method of claim 14, wherein the given task comprises one of (i) determining whether the organization's communications with consumers are governed by the Telephone Consumer Protection Act (TCPA), (ii) determining whether the organization's interactions with consumers that should be flagged for further review as a possible violation of Unfair or Deceptive Acts or Practices (UDAAP), or (iii) determining whether the organization's interactions with consumers violate fair lending regulations.

16. The method of claim 13, wherein the at least one defined set of input questions are produced based on one or more input templates that are tailored to the given task.

17. The method of claim 13, wherein the mechanistic interpretability investigation of the given deep-learning AI model involves one or more of (i) a direct attribution technique, (ii) an activation patching technique, or (iii) a path patching technique.

18. The method of claim 13, wherein utilizing the mechanistic explanations for the given deep-learning AI model's performance of the given task as a basis for quantizing the given deep-learning AI model comprises:
utilizing the mechanistic explanations for the given deep-learning AI model's performance of the given task as a basis for producing multiple quantized versions of the given deep-learning AI model that differ from one another with respect to one or both of (a) which subset of the given deep-learning AI model's parameters had their precision frozen during quantization and (b) which quantization strategy was utilized to reduce a precision of the given deep-learning AI model's parameters that did not have their precision frozen during quantization; and
Selecting a given one of the multiple quantized versions of the given deep-learning AI model as a final quantized version of the given deep-learning AI model.

19. The method of claim 18, wherein, for each of the multiple quantized versions of the given deep-learning AI model, the subset of parameters that had their precision frozen during quantization was determined based on the mechanistic explanations for the given deep-learning AI model's performance of the given task.

20. The method of claim 19, wherein, for each of the multiple quantized versions of the given deep-learning AI model, the subset of parameters that had their precision frozen during quantization comprises parameters associated with a respective subset of the given deep-learning AI model's internal aspects that is selected based on the mechanistic explanations for the given deep-learning AI model's performance of the given task.
